(19) United States
(12) Patent Application Publication
(10) Pub. No.: US 2026/0063913 A1
(43) Pub. Date: Mar. 5, 2026

(54) WEARABLE DEVICE INCLUDING PLURALITY OF FASTENING UNITS

(71) Applicant: SAMSUNG ELECTRONICS CO., LTD., Suwon-si (KR)

(72) Inventors: Gisoo LIM, Suwon-si (KR); Jongmin YOON, Suwon-si (KR); Byounghee LEE, Suwon-si (KR); Hyunseung YOON, Suwon-si (KR)

(21) Appl. No.: 19/379,777

(22) Filed: Nov. 5, 2025

Related U.S. Application Data
(63) Continuation of application No. PCT/KR2024/006556, filed on May 14, 2024.

(30) Foreign Application Priority Data
May 18, 2023 (KR) 10-2023-0064543
Jun. 21, 2023 (KR) 10-2023-0079381

(51) Int. Cl. G02B 27/01

(52) U.S. Cl. CPC G02B 27/0176; G02B 2027/0152; G02B 2027/0154; G02B 2027/0163; G02B 2027/0178

(57) ABSTRACT

A wearable device includes a first housing, a second housing spaced apart from the first housing, a first support member connected to the first housing, a second support member connected to the second housing, a first fastening unit connecting the first housing and the second housing, a second fastening unit connecting the first support member and the second support member, and a length adjustment unit adjusting a length of each of the first fastening unit and the second fastening unit.

### CROSS-REFERENCE TO RELATED APPLICATIONS

This application is a continuation application, under 35 U.S. C. § 111(a), of International Patent Application No. PCT/KR2024/006556, filed on May 14, 2024, which claims priority to Korean Patent Application No. 10-2023-0064543, filed on May 18, 2023 and Korean Patent Application No. 10-2023-0079381, filed on Jun. 21, 2023, the contents of which in their entirety are herein incorporated by reference.

### BACKGROUND

### 1. Field

Embodiments disclosed in the disclosure relates to a wearable device including a plurality of fastening units.

### 2. Description of the Related Art

As technology advances, various types of electronic devices have been developed, and electronic devices are used in various ways to suit a living environment of a user. For example, examples of electronic devices include portable communication devices such as smartphones, tablet personal computers (PCs), or laptops, as well as wearable devices such as smartwatches or head mounted displays.

As an example of an electronic device, a wearable device may be mounted on a body of a user and may provide various information by generating and displaying a virtual image in front of the user through a display panel.

For example, a wearable device may provide the user with virtual reality (VR), mixed reality (MR), or extended reality (XR) experiences. Wearable devices may be utilized in a variety of industries.

### SUMMARY

Since wearable devices are worn on a body (e.g., head) of a user and used, convenience and ease of putting on and taking off the wearable device are important issues for wearable devices. Since the body structure, shape, and size of each user are different, a fastening unit of the wearable device needs to be flexibly deformed and adjusted. For example, a typical single-band structure has limitations in adapting to the body structure of the user and provides limited support to partial areas (e.g., forehead or back of head), which may cause discomfort and fatigue to the user.

In an embodiment of the disclosure, the wearable device may provide a user with wearing convenience. In addition, in an embodiment, the wearable device may be space-efficient and provide manufacturing economy.

The technical goals to be achieved through embodiments of the disclosure are not limited to those described above, and other technical goals not mentioned above are clearly understood by one of ordinary skill in the art from the following description.

A wearable device in an embodiment includes a first housing, a second housing spaced apart from the first housing, a first support member connected to the first housing, a second support member connected to the second housing, a first fastening unit connecting the first housing and the second housing, a second fastening unit connecting the first support member and the second support member, and a length adjustment unit adjusting a length of each of the first fastening unit and the second fastening unit.

In addition, a wearable device in an embodiment includes a first housing accommodating a first electronic component, a second housing accommodating a second electronic component and spaced apart from the first housing, a first support member connected to the first housing, a second support member connected to the second housing, a first fastening unit that includes a connecting unit electrically connecting the first electronic component and the second electronic component, and connects the first housing and the second housing, a second fastening unit that is disposed closer to an inner center of the wearable device than the first fastening unit is to the inner center of the wearable device, and connects the first support member and the second support member, and a length adjustment unit adjusting a length of each of the first fastening unit and the second fastening unit.

### BRIEF DESCRIPTION OF DRAWINGS

The above and other embodiments, advantages and features of this disclosure will become more apparent by describing in further detail embodiments thereof with reference to the accompanying drawings.

FIG. 1 is a block diagram illustrating embodiments of an electronic device in a network environment.

FIG. 2 is a perspective view illustrating an embodiment of an internal configuration of a wearable device.

FIG. 3A is a diagram illustrating an embodiment of a front surface of a wearable device.

FIG. 3B is a diagram illustrating an embodiment of a rear surface of a wearable device.

FIG. 4A is a perspective view of an embodiment of a wearable device.

FIG. 4B is a plan view of an embodiment of a wearable device.

FIG. 5A is a plan view illustrating an embodiment of a state in which a wearable device is worn.

FIG. 5B is a side view illustrating an embodiment of a state in which a wearable device is worn.

FIG. 6A is a plan view illustrating an embodiment of a state in which a wearable device is worn.

FIG. 6B is a side view illustrating an embodiment of a state in which a wearable device is worn.

FIG. 7A is a plan view illustrating an embodiment of a state in which a wearable device is worn.

FIG. 7B is a plan view illustrating an embodiment of a state in which a wearable device is worn.

FIG. 8A is a perspective view of an embodiment of a wearable device.

FIG. 8B is a diagram illustrating an embodiment of a partial area of a wearable device.

FIG. 8C is a plan view of an embodiment of a length adjustment unit of a wearable device.

FIG. 8D is a rear perspective view of an embodiment of a length adjustment unit of a wearable device.

FIG. 8E is a plan view of an embodiment of a length adjustment unit of a wearable device.

FIG. 8F is a rear perspective view of an embodiment of a length adjustment unit of a wearable device.

FIG. 9A is a diagram illustrating an embodiment of a partial area of a wearable device.

FIG. 9B is a diagram illustrating an embodiment of a length adjustment unit.

FIG. 10 is a cross-sectional view illustrating an embodiment of a length adjustment unit.

FIG. 11A is a block diagram of an embodiment of a length adjustment unit.

FIG. 11B is a diagram illustrating an embodiment of an operation of a sensor.

FIG. 12A is a perspective view of an embodiment of a support member.

FIG. 12B is a cross-sectional view of an embodiment of a support member.

FIG. 13A is a perspective view of an embodiment of a support member.

FIG. 13B is a cross-sectional view of an embodiment of a support member.

FIG. 14 is a perspective view of an embodiment of a support member.

FIG. 15 is a perspective view of an embodiment of a support member.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

It should be appreciated that various embodiments of the disclosure and the terms used therein are not intended to limit the technical features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other feature (e.g., importance or order). It is to be understood that when an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, in an embodiment, the module may be implemented in a form of an application-specific integrated circuit (ASIC).

Various embodiments as set forth herein may be implemented as software (e.g., a program 140) including one or more instructions that are stored in a storage medium (e.g., internal memory 136 or external memory 138) that is readable by a machine (e.g., an electronic device). For example, a processor of the machine (e.g., the electronic device) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In an embodiment, a method according to the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. When distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

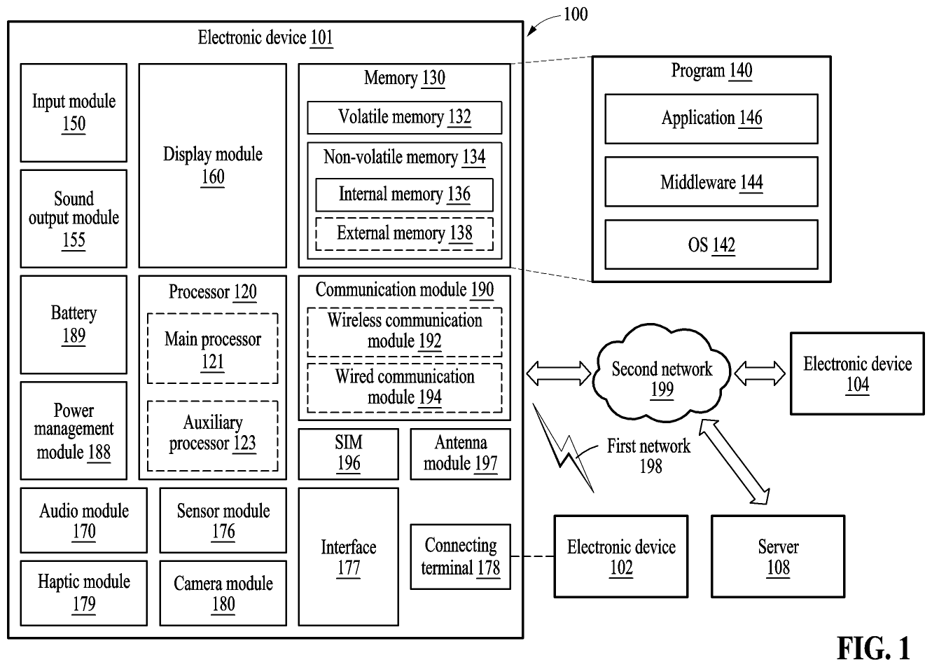

FIG. 1 is a block diagram illustrating an embodiment of an electronic device 101 in a network environment 100. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). In an embodiment, the electronic device 101 may communicate with the electronic device 104 via the server 108. In an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the above components may be omitted from the electronic device 101, or one or more other components may be added in the electronic device 101. In an embodiment, some of the components (e.g., the sensor module 176, the camera module 180, or the antenna module 197) may be integrated as a single component (e.g., the display module 160).

The processor 120 may execute software (e.g., a program 140) to control at least one other component (e.g., a hardware or software component) of the electronic device 101 connected to the processor 120, and may perform various data processing or computation, for example. In an embodiment, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. In an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be predetermined to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is in an active state (e.g., executing an application). In an embodiment, the auxiliary processor 123 (e.g., an ISP or a CP) may be implemented as a portion of another component (e.g., the camera module 180 or the communication module 190) that is functionally related to the auxiliary processor 123. In an embodiment, the auxiliary processor 123 (e.g., an NPU) may include a hardware structure specified for artificial intelligence (AI) model processing. The AI model may be generated by machine learning. Such learning may be performed by the electronic device 101 in which artificial intelligence is performed, or performed via a separate server (e.g., the server 108), for example. Learning algorithms may include, but are not limited to supervised learning, unsupervised learning, semi-supervised learning, or reinforcement learning, for example. The AI model may include a plurality of artificial neural network layers. An artificial neural network may include a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, for example, but is not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, software (e.g., the program 140) and input data or output data for a command related thereto, for example. The memory 130 may include the volatile memory 132 or the non-volatile memory 134.

The program 140 may be stored as software in the memory 130 and may include an operating system (OS) 142, middleware 144, or an application 146, for example.

The input module 150 may receive a command or data to be used by another component (e.g., the processor 120) of the electronic device 101, from the outside (e.g., a user) of the electronic device 101. The input module 150 may include a microphone, a mouse, a keyboard, a key (e.g., a button), or a digital pen (e.g., a stylus pen), for example.

The sound output module 155 may output a sound signal to the outside of the electronic device 101. The sound output module 155 may include a speaker or a receiver, for example. The speaker may be used for general purposes, such as playing multimedia or playing record. The receiver may be used to receive an incoming call. In an embodiment, the receiver may be implemented separately from the speaker or as a portion of the speaker.

The display module 160 may visually provide information to the outside (e.g., a user) of the electronic device 101. The display module 160 may include a display, a hologram device, or a projector and control circuitry to control a corresponding one of the display, the hologram device, and the projector, for example. In an embodiment, the display module 160 may include a touch sensor adapted to sense a touch, or a pressure sensor adapted to measure an intensity of a force incurred by the touch.

The audio module 170 may convert a sound into an electric signal or vice versa. In an embodiment, the audio module 170 may obtain the sound via the input module 150 or output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. In an embodiment, the sensor module 176 may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor, for example.

The interface 177 may support one or more specified protocols to be used for the electronic device 101 to be coupled with the external electronic device (e.g., the electronic device 102) directly (e.g., by wire) or wirelessly. In an embodiment, the interface 177 may include a high-definition multimedia interface (HDMI), a universal serial bus (USB) interface, a secure digital (SD) card interface, or an audio interface, for example.

The connecting terminal 178 may include a connector via which the electronic device 101 may be physically connected to an external electronic device (e.g., the electronic device 102). In an embodiment, the connecting terminal 178 may include an HDMI connector, a USB connector, an SD card connector, or an audio connector (e.g., a headphone connector), for example.

The haptic module 179 may convert an electric signal into a mechanical stimulus (e.g., a vibration or a movement) or an electrical stimulus which may be recognized by a user via his or her tactile sensation or kinesthetic sensation. In an embodiment, the haptic module 179 may include a motor, a piezoelectric element, or an electric stimulator, for example.

The camera module 180 may capture a still image and moving images. In an embodiment, the camera module 180 may include one or more lenses, image sensors, ISPs, or flashes.

The power management module 188 may manage power supplied to the electronic device 101. In an embodiment, the power management module 188 may be implemented as, e.g., at least a part of a power management integrated circuit (PMIC).

The battery 189 may supply power to at least one component of the electronic device 101. In an embodiment, the battery 189 may include a primary cell which is not rechargeable, a secondary cell which is rechargeable, or a fuel cell, for example.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently of the processor 120 (e.g., an AP) and that support a direct (e.g., wired) communication or a wireless communication. In an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a relatively high data transmission rate. The wireless communication module 192 may support various technologies for securing performance on a high-frequency band, such as, e.g., beamforming, massive multiple-input and multiple-output (massive MIMO), full dimensional MIMO (FD-MIMO), an array antenna, analog beam-forming, or a relatively large scale antenna. The wireless communication module 192 may support various requirements specified in the electronic device 101, an external electronic device (e.g., the electronic device 104), or a network system (e.g., the second network 199). In an embodiment, the wireless communication module 192 may support a peak data rate (e.g., 20 gigabits per second (Gbps) or more) for implementing eMBB, loss coverage (e.g., 164 dB or less) for implementing mMTC, or U-plane latency (e.g., 0.5 millisecond (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. In an embodiment, the antenna module 197 may include an antenna including a radiating element including a conductive material or a conductive pattern formed in or on a substrate (e.g., a printed circuit board (PCB)). In an embodiment, the antenna module 197 may include a plurality of antennas (e.g., array antennas). In such a case, at least one antenna appropriate for a communication scheme used in a communication network, such as the first network 198 or the second network 199, may be selected by, e.g., the communication module 190 from the plurality of antennas. The signal or power may be transmitted or received between the communication module 190 and the external electronic device via the at least one selected antenna. In an embodiment, another component (e.g., a radio frequency integrated circuit (RFIC)) other than the radiating element may be additionally formed as a part of the antenna module 197.

In embodiments, the antenna module 197 may form a mmWave antenna module. In an embodiment, the mmWave antenna module may include a PCB, an RFIC disposed on a first surface (e.g., a bottom surface) of the PCB or next (adjacent) to the first surface and capable of supporting a designated a high-frequency band (e.g., the mmWave band), and a plurality of antennas (e.g., array antennas) disposed on a second surface (e.g., a top or a side surface) of the PCB, or next (adjacent) to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

In an embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. In an embodiment, all or some of operations to be executed by the electronic device 101 may be executed at one or more external electronic devices (e.g., the external devices 102 and 104, and the server 108). For example, when the electronic device 101 needs to perform a function or a service automatically, or in response to a request from a user or another device, the electronic device 101, instead of, or in addition to, executing the function or the service, may request one or more external electronic devices to perform at least a portion of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or MEC. In another embodiment, the external electronic device 104 may include an Internet-of-things (IoT) device. The server 108 may be an intelligent server using machine learning and/or a neural network. In an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device in embodiments may be one of various types of electronic devices. The electronic device may include a portable communication device (e.g., a smartphone), a computer device, a portable multimedia device, a portable medical device, a camera, a wearable device, or a home appliance device, for example. In an embodiment of the disclosure, the electronic device is not limited to those described above.

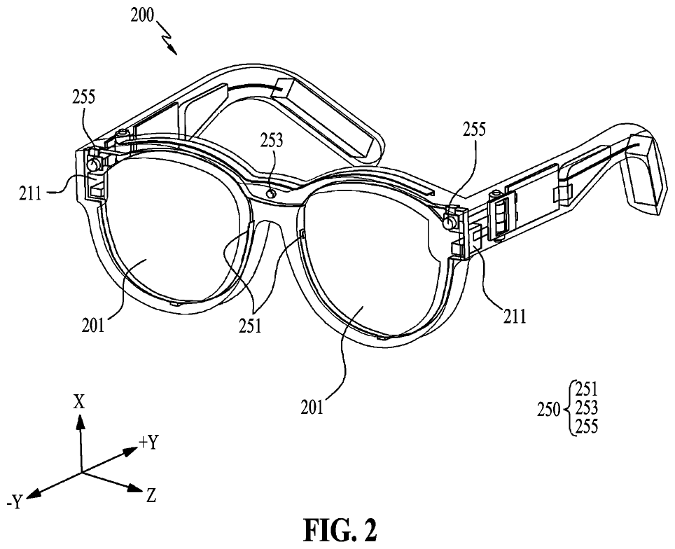

FIG. 2 is a perspective view illustrating an embodiment of an internal configuration of a wearable device of the disclosure.

Referring to FIG. 2, a wearable device 200 (e.g., the electronic device 101 of FIG. 1) in an embodiment of the disclosure may include at least one of a light output module 211, a display member 201, and a camera module 250.

In an embodiment of the disclosure, the light output module 211 may include a light source to output an image and a lens to guide an image to the display member 201. In an embodiment of the disclosure, the light output module 211 may include at least one of a liquid crystal display (LCD), a digital mirror device (DMD), a liquid crystal on silicon (LCoS), an organic light-emitting diode (OLED), or a micro light-emitting diode (micro LED).

In an embodiment of the disclosure, the display member 201 may include an optical waveguide (e.g., a waveguide). In an embodiment of the disclosure, an image output by the light output module 211 incident to one end of the optical waveguide may be propagated inside the optical waveguide and provided to the user. In an embodiment of the disclosure, the optical waveguide may include at least one diffractive element (e.g., a diffractive optical element (DOE) and a holographic optical element (HOE)) or at least one of reflective elements (e.g., a reflection mirror). For example, the optical waveguide may guide the image output by the light output module 211 to the eyes of the user using the at least one diffractive element or the reflective element.

In an embodiment of the disclosure, the camera module 250 may capture a still image and/or a moving image. In an embodiment, the camera module 250 may be disposed within a lens frame and disposed around the display member 201.

In an embodiment of the disclosure, a first camera module 251 may capture and/or recognize a trajectory of a gaze or eye (e.g., a pupil or an iris) of the user. In an embodiment of the disclosure, the first camera module 251 may periodically or aperiodically transmit information (e.g., trajectory information) associated with the trajectory of the gaze or eye of the user to a processor (e.g., the processor 120 of FIG. 1).

In an embodiment of the disclosure, a second camera module 253 may capture an external image.

In an embodiment of the disclosure, a third camera module 255 may be used for hand detection and tracking and for recognition of a gesture (e.g., a hand gesture) of the user. The third camera module 255 in an embodiment of the disclosure may be used for three degrees of freedom (3DoF) and six degrees of freedom (6DoF) head tracking, recognition of a position (space and environment), and/or recognition of a movement. The second camera module 253 may also be used for hand detection and tracking and for recognition of a gesture of the user according to the disclosure. In an embodiment of the disclosure, at least one of the first camera module 251 to the third camera module 255 may be replaced by a sensor module (e.g., a light detection and ranging (LiDAR) sensor). For example, the sensor module may include at least one of a vertical-cavity surface-emitting laser (VCSEL), an infrared sensor, and/or a photodiode.

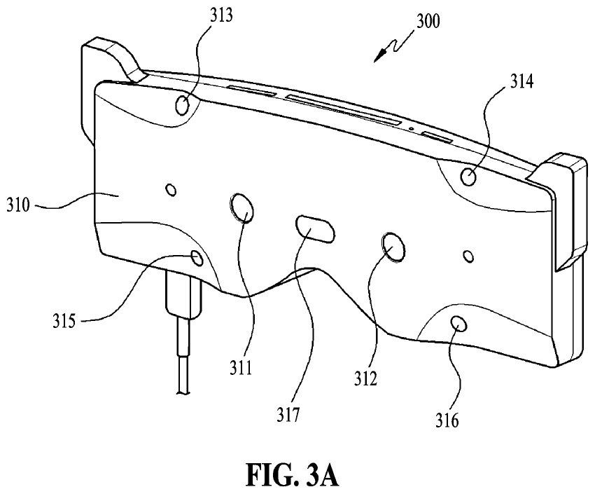

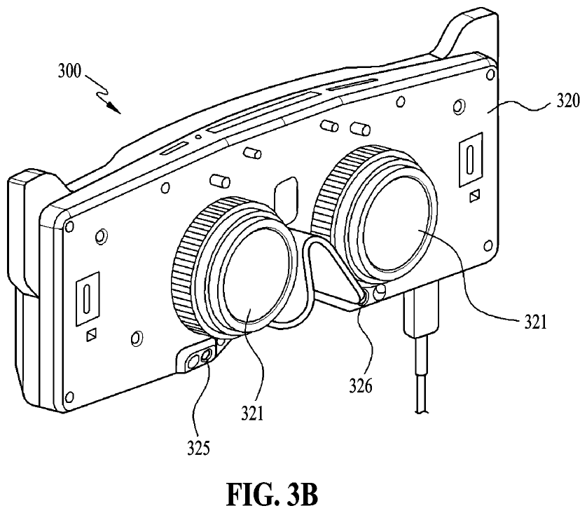

FIGS. 3A and 3B are diagrams illustrating an embodiment of a front surface and a rear surface of a wearable device.

Referring to FIGS. 3A and 3B, in an embodiment, camera modules 311, 312, 313, 314, 315, and 316 and/or a depth sensor 317 for obtaining information related to a surrounding environment of a wearable device 300 (e.g., the electronic device 101 of FIG. 1 or the wearable device 200 of FIG. 2) may be disposed on a first surface 310 of a housing.

In an embodiment, the camera modules 311 and 312 may obtain an image related to the surrounding environment of the wearable device.

In an embodiment, the camera modules 313, 314, 315, and 316 may obtain an image in a state in which the wearable device is worn by a user. The camera modules 313, 314, 315, and 316 may be used for hand detection and tracking and for recognition of a gesture (e.g., a hand gesture) of the user. The camera modules 313, 314, 315, and 316 may be used for 3DoF and 6DoF head tracking, recognition of a position (space and environment), and/or recognition of a movement. In an embodiment, the camera modules 311 and 312 may be used for hand detection and tracking and for recognition of a gesture of the user.

In an embodiment, the depth sensor 317 may transmit a signal and receive a signal reflected from an object and may be used to determine a distance from an object based on a time of flight (TOF). Instead of or in addition to the depth sensor 317, the camera modules 313, 314, 315, and 316 may determine a distance from an object.

In an embodiment, camera modules 325 and 326 for face recognition and/or a display 321 (and/or a lens) may be disposed on a second surface 320 of the housing.

In an embodiment, the camera modules 325 and 326 for face recognition next (adjacent) to a display may be used to recognize a face of the user or may recognize and/or track both eyes of the user.

In an embodiment, the display 321 (and/or a lens) may be disposed on the second surface 320 of the wearable device 300. In an embodiment, the wearable device 300 may not include the camera modules 315 and 316 among the plurality of camera modules 313, 314, 315, and 316. Although not shown in FIGS. 3A and 3B, the wearable device 300 may further include at least one components among the components shown in FIG. 2.

As described above, the wearable device 300 in an embodiment may have a form factor to be worn on a head of the user. The wearable device 300 may further include a wearing member and/or a strap to be fixed onto a body part of the user. The wearable device 300 in a state of being worn on the head of the user may provide a user experience based on an augmented reality (AR), a virtual reality (VR), and/or a mixed reality (MR).

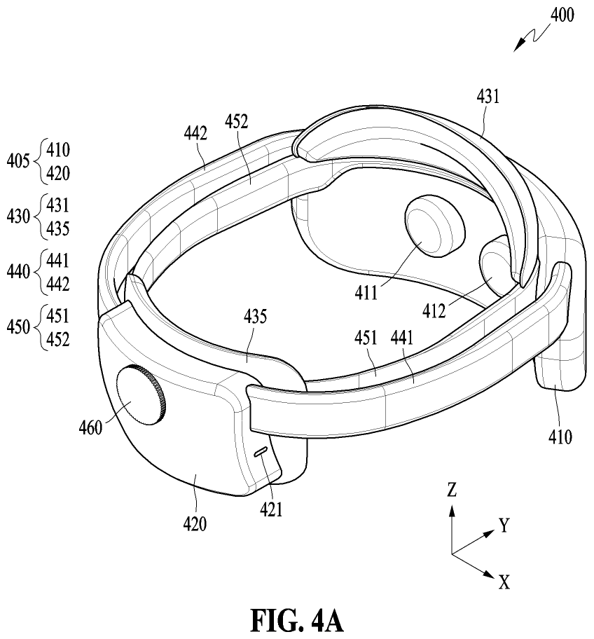

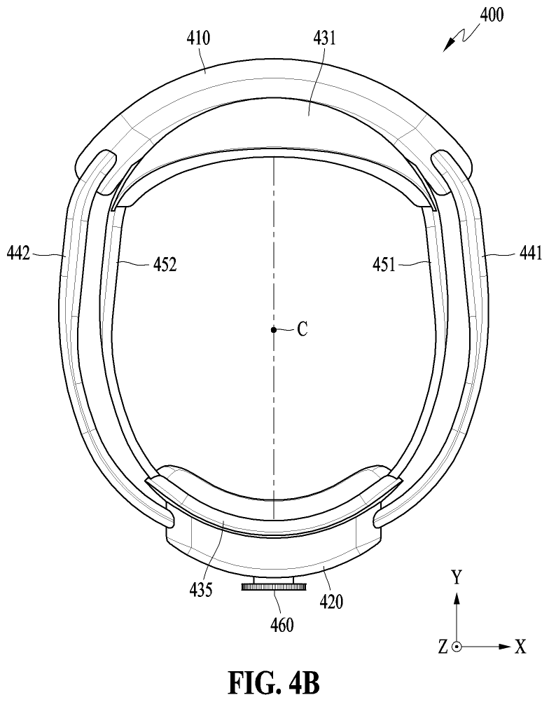

FIG. 4A is a perspective view of an embodiment of a wearable device 400, and FIG. 4B is a plan view of an embodiment of the wearable device 400.

Referring to FIGS. 4A and 4B, the wearable device 400 (e.g., the electronic device 101 of FIG. 1, the wearable device 200 of FIG. 2, or the wearable device 300 of FIGS. 3A and 3B) in an embodiment may include at least some of a plurality of housings 405, a plurality of support members 430, a first fastening unit 440, a second fastening unit 450, and a length adjustment unit 460.

Hereinafter, any repeated description related to the above description is omitted, and it is obvious that a portion of the configuration and structure of the wearable device 400 may be replaced, added, or omitted within a scope easily understandable by one of ordinary skill in the art with reference to the following drawings and descriptions. In addition, at least one component or feature of the embodiments described above may be coupled to the wearable device 400 unless this is technically and clearly infeasible.

In an embodiment, the wearable device 400 may be an electronic device or a wearable electronic device worn on the body of a user. For example, the wearable device 400 may be a head disposed (e.g., mounted) display that is worn on a head of the user and outputs a screen to the user. Hereinafter, for the convenience of description, the wearable device 400 worn on the head of the user will be described, but the wearable device 400 according to various other embodiments is not limited thereto.

In an embodiment, the plurality of housings 405 may accommodate an electronic component (not shown) for driving the wearable device 400 therein. The plurality of housings 405 may protect the electronic component (not shown) accommodated therein from the outside. The plurality of housings 405 may be at least two housings spaced apart from each other. For example, the plurality of housings 405 may include a first housing 410 and a second housing 420.

In an embodiment, the first housing 410 and the second housing 420 may be spaced apart from each other. The first housing 410 and the second housing 420 may be worn on different parts of the body. For example, the first housing 410 may face a face of the user, and the second housing 420 may face the back of the head of the user.

In an embodiment, the first housing 410 may accommodate a first electronic component (not shown). The first electronic component (not shown) may refer to any electronic component accommodated in the first housing 410.

For example, the first electronic component (not shown) may include at least some of a processor (e.g., the processor 120 of FIG. 1), a memory (e.g., the memory 130 of FIG. 1), a sensor module (e.g., the sensor module 176 of FIG. 1), and a camera module (e.g., the camera module 180 of FIG. 1, the camera module 250 of FIG. 2, or the camera modules 311 and 312 of FIGS. 3A and 3B).

In an embodiment, the first electronic component (not shown) may include a display (e.g., the display module 160 of FIG. 1, the light output module 211 of FIG. 2, or the display 321 of FIGS. 3A and 3B). The first housing 410 may include a plurality of lenses 411 and 412, and the display may output a screen through the plurality of lenses 411 and 412.

In an embodiment, the second housing 420 may accommodate a second electronic component (not shown). The second electronic component (not shown) may refer to any electronic component accommodated in the second housing 420.

For example, the second electronic component (not shown) may include at least some of a processor (e.g., the processor 120 of FIG. 1), a memory (e.g., the memory 130 of FIG. 1), a sensor module (e.g., the sensor module 176 of FIG. 1), a battery (e.g., the battery 189 of FIG. 1), a communication module (e.g., the communication module 190 of FIG. 1), and an antenna module (e.g., the antenna module 197 of FIG. 1).

In an embodiment, the second housing 420 may include a terminal portion 421 that is electrically connected to an external device. Through the terminal portion 421, the wearable device 400 may receive an electric signal or power from an external device.

In an embodiment, the plurality of housings 405 may divide and arrange the plurality of electronic components (not shown) of the wearable device 400, thereby reducing a volume and a weight of each of the first housing 410 and the second housing 420, balancing the weight of the entirety of the wearable device 400, and providing wearing convenience to the user.

In an embodiment, the plurality of support members 430 may support the wearable device 400 by being supported externally (e.g., the body of the user). At least some of the plurality of support members 430 may be, but are not limited to, forehead supports, occipital supports, or supports including pads and cushions, and may be implemented in various forms.

In an embodiment, the plurality of support members 430 may include a first support member 431 and a second support member 435. The first support member 431 may be connected to the first housing 410. The second support member 435 may be connected to the second housing 420.

In an embodiment, the first support member 431 and the second support member 435 may be spaced apart from each other. For example, the first support member 431 may be supported on the front or forehead of the head of the user, and the second support member 435 may be supported on the back of the head of the user. Without being limited thereto, the first support member 431 and the second support member 435 may be supported on various parts of the body of the user, such as opposite sides of the head, the neck, and the shoulders.

In an embodiment, the first fastening unit 440 may connect the first housing 410 and the second housing 420. The first fastening unit 440 may be, but is not limited to, a band, belt, or cable having elasticity or flexibility, or may be implemented in various forms. The first fastening unit 440 may include a first fastening member 441 and a second fastening member 442.

For example, the first fastening member 441 may be connected to one side (e.g., +X direction) end portion of the first housing 410 and one side (e.g., +X direction) end portion of the second housing 420, respectively. The second fastening member 442 may be connected to an opposite side (e.g., −X direction) end portion of the first housing 410 and an opposite side (e.g., −X direction) end portion of the second housing 420, respectively.

In an embodiment, the first fastening unit 440 may include a connecting unit (not shown) that electrically connects the first housing 410 and the second housing 420. The connecting unit (not shown) may electrically connect the first electronic component (not shown) and the second electronic component (not shown).

In an embodiment, the connecting unit (not shown) may include at least a portion of a cable, a wire, or a flexible printed circuit board (FPCB). Through the connecting unit (not shown), the wearable device 400 may divide and arrange the electronic components (not shown) in the two housings 410 and 420.

In an embodiment, the second fastening unit 450 may connect the first support member 431 and the second support member 435. The second fastening unit 450 may be, but is not limited to, a band, belt, or cable having elasticity or flexibility, or may be implemented in various forms. The second fastening unit 450 may include a third fastening member 451 and a fourth fastening member 452.

For example, the third fastening member 451 may be connected to one side (e.g., +X direction) end portion of the first support member 431 and one side (e.g., +X direction) end portion of the second support member 435, respectively. The fourth fastening member 452 may be connected to an opposite side (e.g., −X direction) end portion of the first support member 431 and an opposite side (e.g., −X direction) end portion of the second support member 435, respectively.

In an embodiment, the second fastening unit 450 may be disposed closer to an inner center C of the wearable device 400 than the first fastening unit 440 is to the inner center C. In an alternative embodiment, the second fastening unit 450 may be disposed closer to the body of the user than the first fastening unit 440 is to the body of the user.

In an embodiment, the first fastening unit 440 and the second fastening unit 450 may be spaced apart from each other in a horizontal direction (e.g., in the X-axis direction). For example, the first fastening member 441 of the first fastening unit 440 may be disposed on one side (e.g., the +X direction) of the third fastening member 451 of the second fastening unit 450, and the second fastening member 442 of the first fastening unit 440 may be disposed on an opposite side (e.g., the −X direction) of the fourth fastening member 452 of the second fastening unit 450.

In an embodiment, the wearable device 400 may form exterior uniformity and aesthetics, reduce a length in a vertical direction (e.g., Y-axis direction), and provide convenience in storage and movement. Also, the wearable device 400 may reduce pressure applied to an upper part of the head of the user.

In an embodiment, the first fastening unit 440 may adjust a gap between the first housing 410 and the second housing 420 so that the wearable device 400 is worn by the user while maintaining the overall appearance of the wearable device 400, and the second fastening unit 450 may adjust a gap between the first support member 431 and the second support member 435 in response to the body of the user.

In an embodiment, the second fastening unit 450 may contact the body of the user, and the first fastening unit 440 may be disposed outside the second fastening unit 450 so as not to contact the body of the user. The wearable device 400 may improve the wearability of the user as the first fastening unit 440 is spaced apart from the body of the user.

In an embodiment, the second fastening unit 450 may include or consist of a material that is relatively more flexible than the first fastening unit 440. Since the first fastening unit 440 includes a connecting unit (not shown) therein, the first fastening unit 440 may include or consist of a rigid material to protect the connecting unit (not shown). In order to improve convenience of the user, the second fastening unit 450 may include or consist of a flexible material, and may include or consist of a cushion, pad, or mesh material in at least a partial area.

In an embodiment herein, the first fastening unit 440 and the second fastening unit 450 are including or consisting of different materials, so that the first fastening unit 440 may stably support the first housing 410 and the second housing 420 and protect the connecting unit (not shown) therein, and the second fastening unit 450 may improve the wearing convenience to the user.

In an embodiment, the length adjustment unit 460 may adjust the length of each of the first fastening unit 440 and the second fastening unit 450. The user may easily and conveniently attach and detach the plurality of housings 405 and the plurality of support members 430 through the length adjustment unit 460.

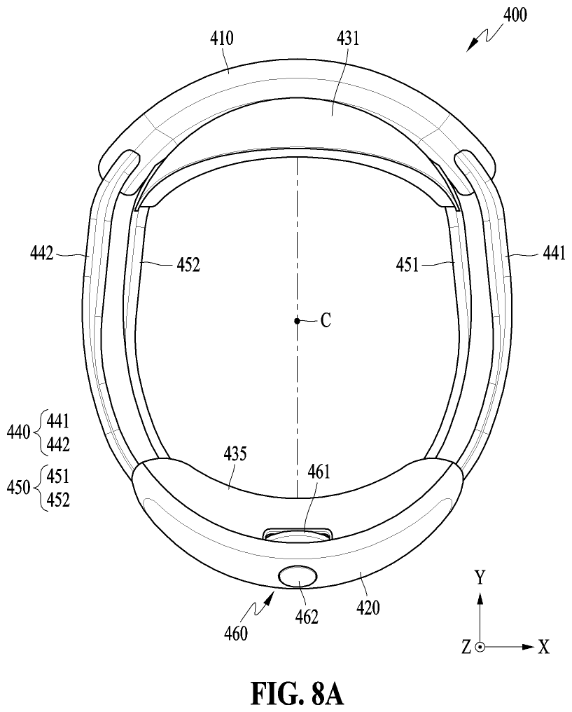

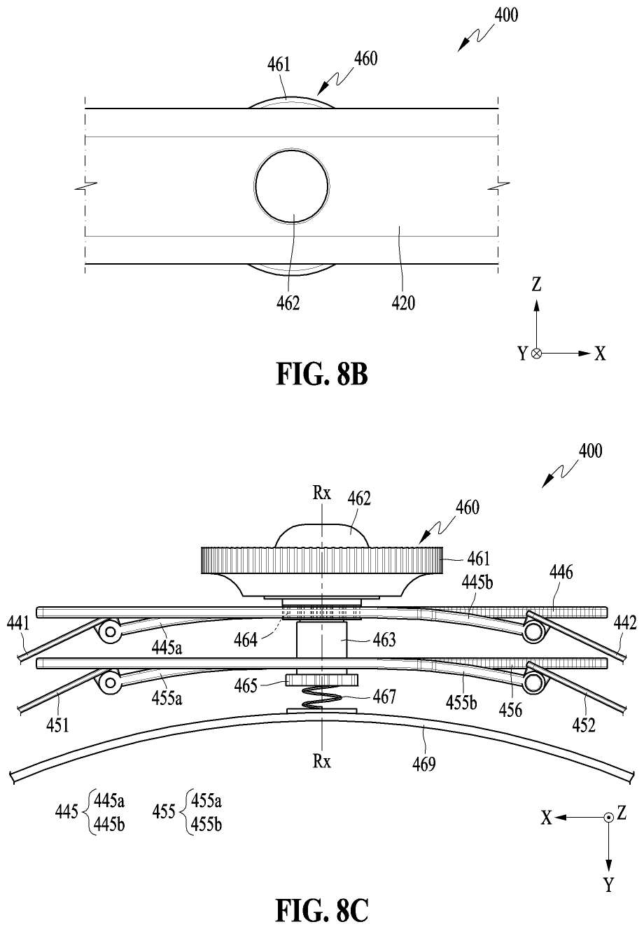

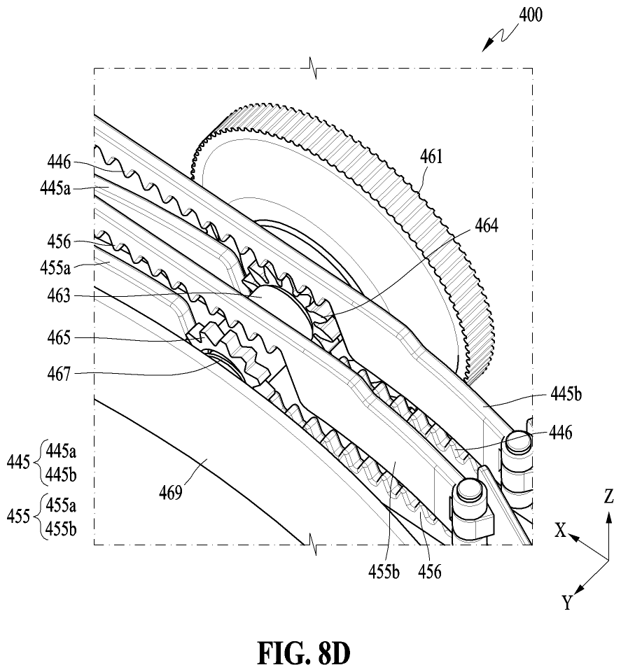

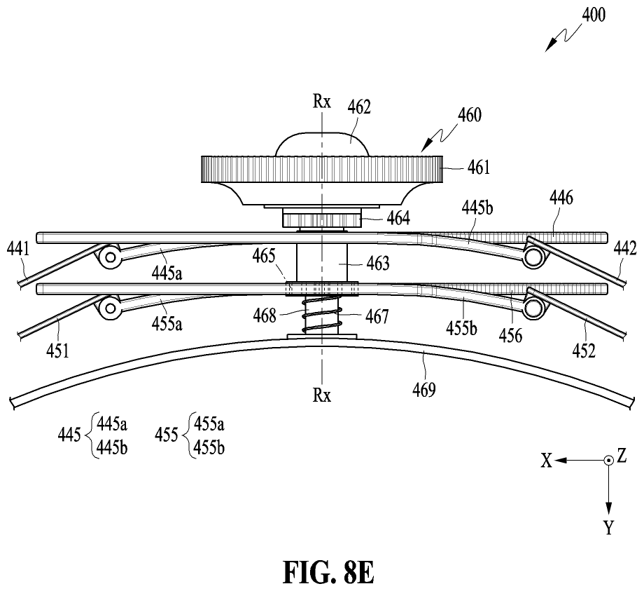

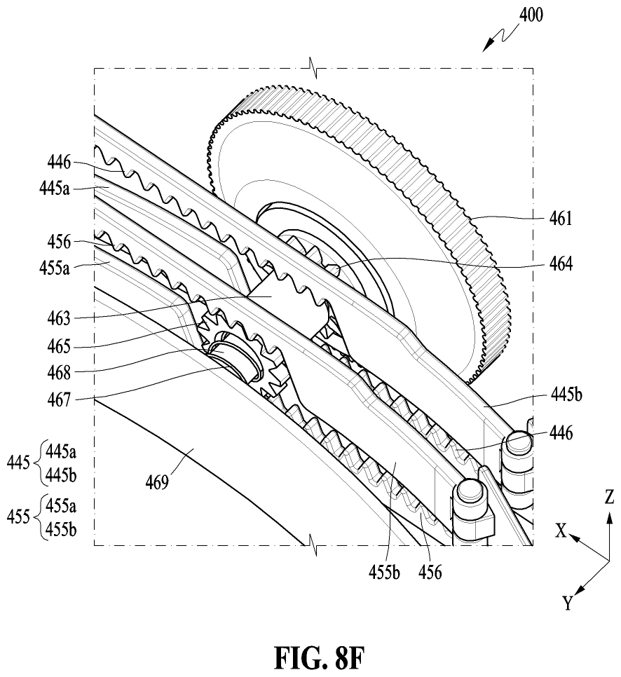

In an embodiment, the length adjustment unit 460 may adjust the gap between the first housing 410 and the second housing 420 by adjusting the length of the first fastening unit 440. For example, the length adjustment unit 460 may adjust a distance between the first housing 410 and the second housing 420 by adjusting the length of at least a portion of the first fastening member 441, the second fastening member 442, or another component (e.g., a first connecting member 445 of FIG. 8C) of the first fastening unit 440.

In an embodiment, the length adjustment unit 460 may adjust the gap between the first support member 431 and the second support member 435 by adjusting the length of the second fastening unit 450. For example, the length adjustment unit 460 may adjust a distance between the first support member 431 and the second support member 435 by adjusting the length of at least a portion of the third fastening member 451, the fourth fastening member 452, or another component (e.g., a second connecting member 455 of FIG. 8C) of the second fastening unit 450.

In an embodiment, the length adjustment unit 460 may adjust at least a portion of a shape of the first support member 431 and a shape of the second support member 435 by adjusting the length of the second fastening unit 450.

For example, the plurality of support members 430 may include or consist of a relatively soft material or elastic body and may have greater flexibility than flexibility of the plurality of housings 405. When elasticity is applied to the second fastening unit 450, at least a portion of at least one of the first support member 431 and the second support member 435 may be bent or folded, and the shape thereof may be temporarily deformed.

In an embodiment herein, the length adjustment unit 460 may provide the user with wearing comfort by adjusting the length of each of the first fastening unit 440 and the second fastening unit 450 to fit the head of the user.

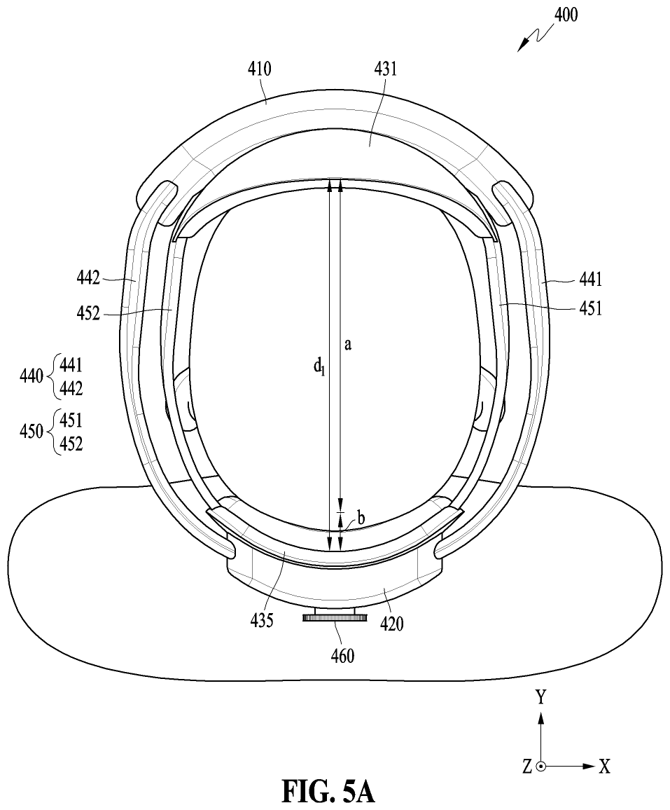

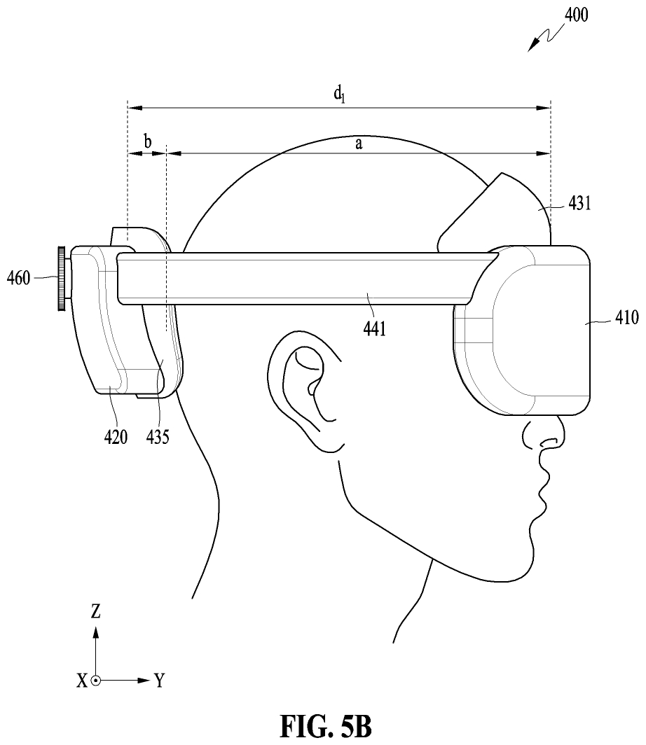

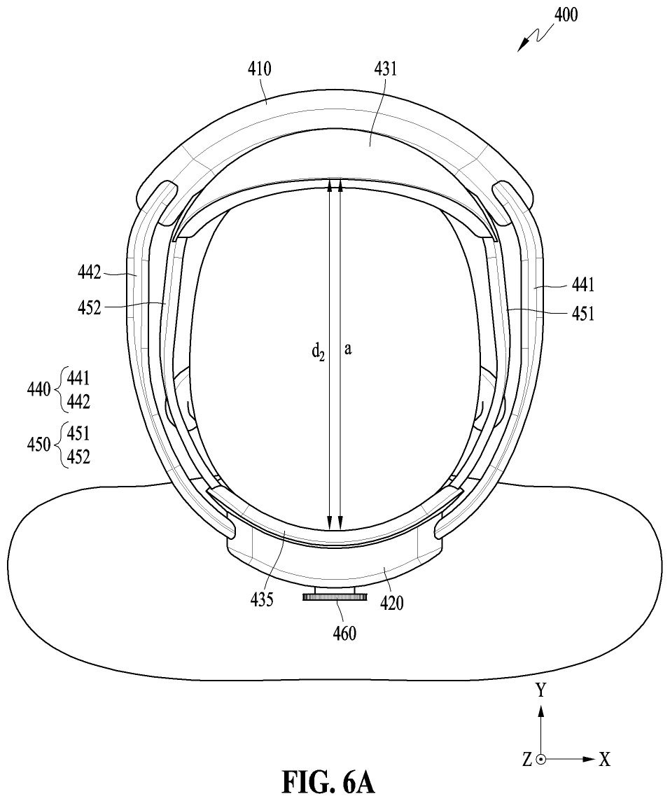

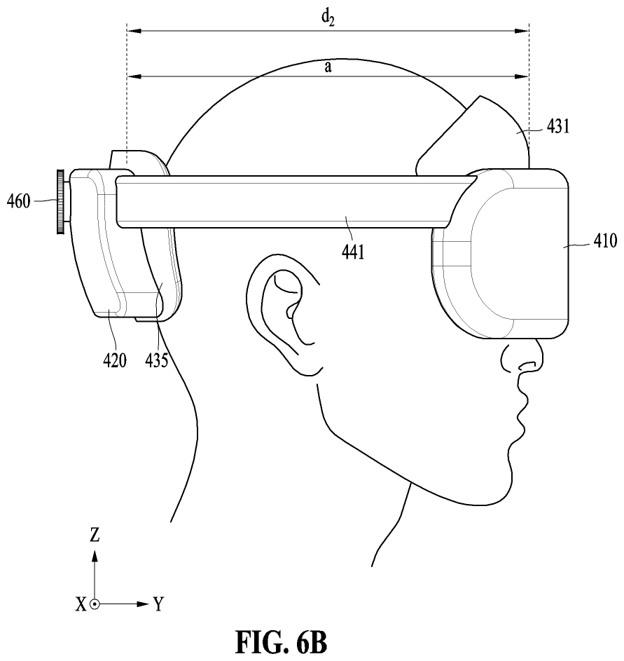

FIG. 5A is a plan view illustrating an embodiment of a state in which the wearable device 400 is worn, FIG. 5B is a side view illustrating an embodiment of a state in which the wearable device 400 is worn, FIG. 6A is a plan view illustrating an embodiment of a state in which the wearable device 400 is worn, and FIG. 6B is a side view illustrating an embodiment of a state in which the wearable device 400 is worn.

Referring to FIGS. 5A, 5B, 6A, and 6B, the wearable device 400 in an embodiment may adjust the gap between the first housing 410 and the second housing 420 to fit the head of the user.

Specifically, FIGS. 5A and 5B are diagrams illustrating states before the length of the first fastening unit 440 of the wearable device 400 is adjusted, and FIGS. 6A and 6B are diagrams illustrating states after the length of the first fastening unit 440 of the wearable device 400 is adjusted.

Hereinafter, any repeated description related to the above description is omitted, and it is obvious that a portion of the configuration and structure of the wearable device 400 may be replaced, added, or omitted within a scope easily understandable by one of ordinary skill in the art with reference to the following drawings and descriptions. In addition, at least one component or feature of the embodiments described above may be coupled to the wearable device 400 unless this is technically and clearly infeasible.

In an embodiment, a first length d1 may represent the gap between the first housing 410 and the second housing 420 before the length of the first fastening unit 440 is adjusted or in a state in which the wearable device 400 starts to be worn. The first length d1 may be greater than a width a of the head of the user in a front-back direction (e.g., Y-axis direction) by a margin b.

In an embodiment, before the wearable device 400 is worn, the length adjustment unit 460 may adjust the length of the first fastening unit 440 to increase the gap between the first housing 410 and the second housing 420 to the first length d1. In an alternative embodiment, the first length d1 may be the gap between the first housing 410 and the second housing 420 in a standby state before being worn.

In an embodiment, the wearable device 400 with the first length d1 may be temporarily, loosely or adjustably disposed (e.g., mounted) on the head of the user. In an alternative embodiment, the wearable device 400 with the first length d1 may be disposed around the head of the user by the hand of the user or another support. By the margin b, the user may easily and stably start wearing the wearable device 400.

In an embodiment, a second length d2 may represent the gap between the first housing 410 and the second housing 420 after the length of the first fastening unit 440 is adjusted or in a state in which the wearable device 400 is being worn. The second length d2 may be equal to or slightly larger than the width a of the head of the user in the front-back direction.

In an embodiment, when the length of the first fastening unit 440 is adjusted, the gap between the first housing 410 and the second housing 420 may be adjusted to fit the head of the user. When the second length d2 is equal to or slightly larger than the width a of the head of the user in the front-back direction, the length adjustment unit 460 may maintain the length of the first fastening unit 440.

In an embodiment herein, the length adjustment unit 460 may adjust the gap between the first housing 410 and the second housing 420 to fit the head of the user by adjusting the length of the first fastening unit 440, and the wearable device 400 may be deformed to fit the user, thereby providing the wearability to the user.

In an embodiment, the length adjustment unit 460 may maintain the length of the first fastening unit 440 and reduce or maintain the tension of the first fastening unit 440. The length adjustment unit 460 may control the tension of the first fastening unit 440 to provide the user with wearing convenience.

For example, when the tension of the first fastening unit 440 increases, the pressure of the first housing 410 and the second housing 420 applied to the user increases, and the user may feel discomfort. In addition, since the first housing 410 and the second housing 420 may include or consist of a material having relatively more rigidity than rigidity of the first support member 431 and the second support member 435, the discomfort felt by the user may be relatively greater when the first housing 410 and the second housing 420 press on the user.

The length adjustment unit 460 in an embodiment may reduce or maintain the tension of the first fastening unit 440 after adjusting the length of the first fastening unit 440. The length adjustment unit 460 may adjust the first housing 410 and the second housing 420 so as not to excessively press on the user, and may provide the user with wearing convenience.

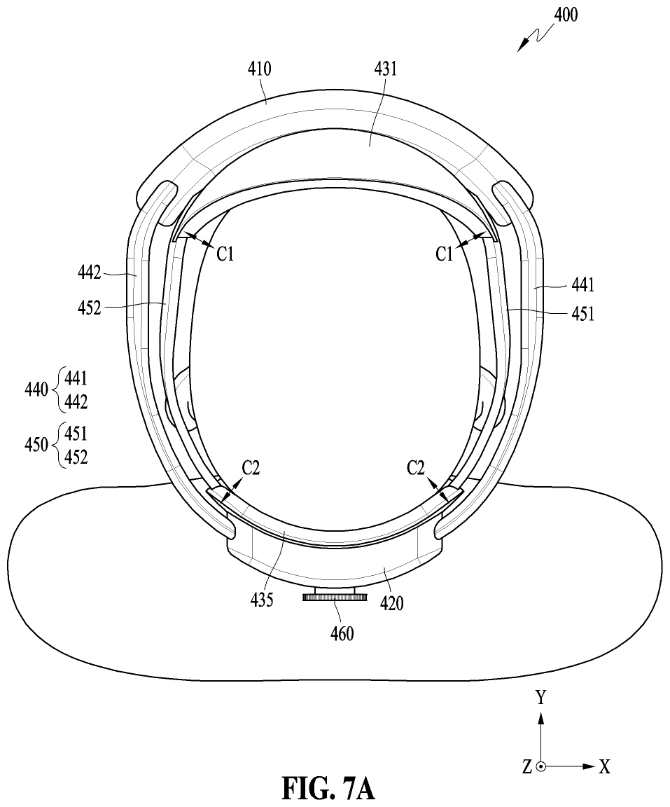

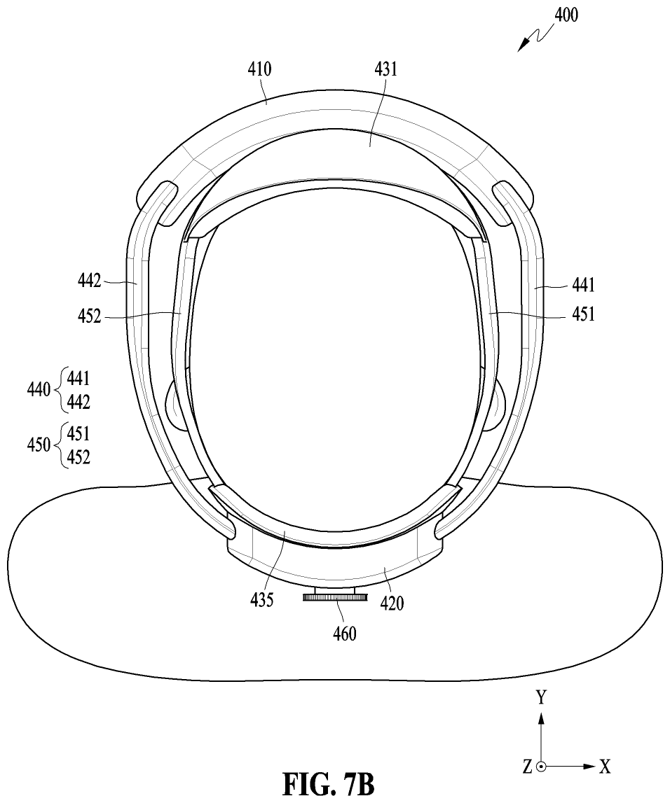

FIG. 7A is a plan view illustrating an embodiment of a state in which the wearable device 400 is worn, and FIG. 7B is a plan view illustrating an embodiment of a state in which the wearable device 400 is worn.

Specifically, FIG. 7A is a diagram illustrating a state before the length of the second fastening unit 450 of the wearable device 400 is adjusted, and FIG. 7B is a diagram illustrating a state after the length of the second fastening unit 450 of the wearable device 400 is adjusted.

Referring to FIGS. 7A and 7B, the wearable device 400 in an embodiment may adjust at least a portion of the gap between the first support member 431 and the second support member 435, the shape of the first support member 431, and the shape of the second support member 435 to fit the head of the user.

Hereinafter, any repeated description related to the above description is omitted, and it is obvious that a portion of the configuration and structure of the wearable device 400 may be replaced, added, or omitted within a scope easily understandable by one of ordinary skill in the art with reference to the following drawings and descriptions. In addition, at least one component or feature of the embodiments described above may be coupled to the wearable device 400 unless this is technically and clearly infeasible.

In an embodiment, after the length of the first fastening unit 440 is adjusted, or in a state in which the wearable device 400 is being worn (e.g., the states of FIGS. 6A and 6B), the first support member 431 and the second support member 435 may not be completely in contact with the head of the user, but may be spaced apart by predetermined gaps C1 and C2.

For example, the first gap C1 may represent the gap between the first support member 431 and the forehead of the user before the length of the second fastening unit 450 is adjusted. The second gap C2 may represent the gap between the second support member 435 and the back of the head of the user before the length of the second fastening unit 450 is adjusted.

In an embodiment, the length adjustment unit 460 may adjust the length of the second fastening unit 450 to bring the first support member 431 and the second support member 435 into close contact with the head of the user in response to the head of the user, or to bring at least a partial area of the first support member 431 and the second support member 435 to contact the head of the user.

In an embodiment, when the length of the second fastening unit 450 is adjusted, the gap between the first support member 431 and the second support member 435 may be adjusted to fit the head of the user. In addition, the length adjustment unit 460 may reduce or remove the first gap C1 and the second gap C2 by deforming the shapes of the first support member 431 and the second support member 435 to fit the head of the user.

In an embodiment, the length adjustment unit 460 may adjust the length of the second fastening unit 450 to adjust the gaps C1 and C2 between the user and the first support member 431 and the second support member 435 to fit the head of the user, and/or the shape of the first support member 431 and the shape of the second support member 435, and the wearable device 400 may be deformed to fit the user, thereby providing the wearability to the user.

In an embodiment, by reducing or removing the first gap C1 and the second gap C2, the first support member 431 and the second support member 435 may be supported to come into close contact with the head of the user, thereby providing the wearing stability of the wearable device 400.

In an embodiment, the length adjustment unit 460 may adjust the length of the first fastening unit 440 and the second fastening unit 450 in various ways. Hereinafter, embodiments for implementing this are described as examples, and the actual implementation is not limited thereto, and at least some configurations may be omitted, replaced, or added, and compatible features of a plurality of embodiments may be combined and implemented.

FIG. 8A is a perspective view of an embodiment of the wearable device 400, FIG. 8B is a diagram illustrating an embodiment of a partial area of the wearable device 400, FIG. 8C is a plan view of an embodiment of the length adjustment unit 460 of the wearable device 400, FIG. 8D is a rear perspective view of an embodiment of the length adjustment unit 460 of the wearable device 400, FIG. 8E is a plan view of an embodiment of the length adjustment unit 460 of the wearable device 400, and FIG. 8F is a rear perspective view of an embodiment of the length adjustment unit 460 of the wearable device 400.

Specifically, FIGS. 8C and 8D are drawings illustrating the length adjustment unit 460 of the wearable device 400 in a state where a handle 461 is in a first position, and FIGS. 8E and 8F are diagrams illustrating the length adjustment unit 460 of the wearable device 400 in a state where the handle 461 is in a second position.

Referring to FIGS. 8A, 8B, 8C, 8D, 8E, and 8F, the wearable device 400 in an embodiment may include at least a portion of the handle 461, the first connecting member 445, and the second connecting member 455.

Hereinafter, the configuration and operation of the length adjustment unit 460 are described with reference to an exemplary structure of the wearable device 400 in an embodiment, and in actual implementation, the configuration and operation may be replaced, added, or omitted in various ways without being limited to the drawings and descriptions.

In an embodiment, the second housing 420 and the second support member 435 may be connected to each other to form a single body. For example, the second support member 435 may be a partial area of the second housing 420 provided on the inside of the wearable device 400. The second support member 435 may be an area next (adjacent) to an area supported on the body of the user when the wearable device 400 is worn by the user. In an alternative embodiment, as in an embodiment of FIGS. 4A and 4B, the second housing 420 and the second support member 435 may be formed by connecting separate components.

In an embodiment, the handle 461 may be a component of the length adjustment unit 460. The handle 461 may be a manipulation unit for adjusting the length of at least one of the first fastening unit 440 and the second fastening unit 450. The handle 461 may rotate along a rotation axis Rx. Without being limited thereto, the handle 461 may be implemented in various forms and structures that may be manipulated by the user, and may be configured as a knob or lever, for example.

In an embodiment, the handle 461 may be provided in one of the first housing 410 or the second housing 420. As shown in FIG. 8B, the handle 461 may be provided in the second housing 420. The handle 461 may be exposed to the outside from the second housing 420 in an up-down direction (e.g., +/−Z direction) so that the user may manipulate the handle 461 with one or two fingers.

In an embodiment, the length adjustment unit 460 may further include a pillar member 463, a first gear 464, a second gear 465, and an elastic member 467. The pillar member 463 may have a pillar shape extending from the handle 461 along the rotation axis Rx. For example, the pillar member 463 may extend in a direction from the second housing 420 toward the second support member 435 (e.g., +Y direction), or in a direction from the second housing 420 toward the inner center C of the wearable device 400 (e.g., +Y direction).

In an embodiment, each of the first gear 464 and the second gear 465 may be provided on an outer circumferential surface of the pillar member 463. The first gear 464 and the second gear 465 may be spaced apart from each other along an extension direction of the pillar member 463.

For example, the first gear 464 may be provided in a partial area of the outer circumferential surface of the pillar member 463 and may be connected to the first fastening unit 440. The second gear 465 may be provided in a different partial area from the first gear 464 on the outer circumferential surface of the pillar member 463, and may be connected to the second fastening unit 450.

In an embodiment, the handle 461 may selectively change the position between the first position and the second position. For example, the first position and the second position may be different positions in the direction (e.g., +Y direction) from the second housing 420 toward the inner center C of the wearable device 400. According to whether the handle 461 is disposed in the first position or the second position, the connection state of the first gear 464 and the second gear 465 may be changed.

The wearable device 400 in an embodiment may adjust each of the length of at least two fastening units 440 and 450 through one handle 461 by changing the position of one handle 461. The wearable device 400 may simplify the configuration and improve space efficiency, provide convenience and intuitiveness in use, and provide economic efficiency in manufacturing.

In an embodiment, the first fastening unit 440 may further include the first connecting member 445. The first connecting member 445 may be engaged with the first gear 464 and the length may vary by the rotation of the first gear 464 in a state where the first fastening unit 440 is connected to the first gear 464. As the length of the first connecting member 445 varies, the length of the first fastening unit 440 may vary.

Hereinafter, a method of adjusting the length of the first fastening unit 440 through the first connecting member 445 in an embodiment will be described as an example with reference to FIGS. 8C and 8D. However, this is only an exemplary method, and in actual implementation of the wearable device 400, the method is not limited thereto, and the length of the first fastening unit 440 may be adjusted in various ways.

In an embodiment, the first connecting member 445 may be provided in plural. The plurality of first connecting members 445 may move to be fixed relative to each other to adjust the length of the first fastening unit 440.

In an embodiment, the plurality of first connecting members 445 may include a first sub-connecting member 445a and a second sub-connecting member 445b. One end portion (e.g., the end portion in the +X direction) of the first sub-connecting member 445a may be connected to the first fastening member 441, and one portion of the first sub-connecting member 445a may be connected to the second sub-connecting member 445b. One end portion (e.g., the end portion in the-X direction) of the second sub-connecting member 445b may be connected to the second fastening member 442, and one portion of the second sub-connecting member 445b may be connected to the first sub-connecting member 445a.

In an embodiment, the first sub-connecting member 445a and the second sub-connecting member 445b may be connected to each other through the first gear 464. The connection portions of the first sub-connecting member 445a and the second sub-connecting member 445b may be changed based on the rotation of the first gear 464.

For example, each of the plurality of first connecting members 445 may include a first rail 446. The first rail 446 may be engaged with the rotation of the first gear 464 and move in a state of being connected to the first gear 464. By the first gear 464 and the first rail 446, the connection portions of the plurality of first connecting members 445 may be changed, and the overall length of the first connecting member 445 may be adjusted.

In an embodiment, the plurality of first connecting members 445 may move to be fixed relative to each other to adjust the length of the first fastening unit 440. As the connection portions of the first sub-connecting member 445a and the second sub-connecting member 445b change, the overlapping length of the first sub-connecting member 445a and the second sub-connecting member 445b may change, and as a result, the length of the first connecting member 445 may change. As the length of the first connecting member 445 changes, the length of the first fastening unit 440 may be adjusted.

In an embodiment, the first connecting member 445 may be provided inside the second housing 420. The first fastening member 441 may be connected to one end portion of the first housing 410 and the first sub-connecting member 445a, and the second fastening member 442 may be connected to an opposite end portion of the first housing 410 opposite to the one end portion and the second sub-connecting member 445b.

In an embodiment, when the length of the first connecting member 445 changes, the distance between the first fastening unit 440 and the second fastening unit 450 may be changed, and the lengths of the first fastening unit 440 and the second fastening unit 450 exposed to the outside of the second housing 420 may be adjusted. By rotating the first gear 464, the first fastening unit 440 and the second fastening unit 450 are introduced into the second housing 420 or discharged outside from the second housing 420, so that the distance between the first housing 410 and the second housing 420 may be adjusted.

In an embodiment, the first connecting member 445 may be a partial configuration of the length adjustment unit 460 or the second housing 420. As the length of the first connecting member 445 varies, the length of the first fastening unit 440 exposed to the outside of the second housing 420 may vary, and in the entirety of the wearable device 400, the gap between the first housing 410 and the second housing 420 may be adjusted.

In an embodiment, the second fastening unit 450 may further include the second connecting member 455. The second connecting member 455 may be engaged with the second gear 465, and the length may vary by the rotation of the second gear 465 in a state where the second fastening unit 450 is connected to the second gear 465. As the length of the second connecting member 455 varies, the length of the second fastening unit 450 may vary.

Hereinafter, a method of adjusting the length of the second fastening unit 450 through the second connecting member 455 in an embodiment will be described as an example with reference to FIGS. 8E and 8F. However, this is only an exemplary method, and in actual implementation of the wearable device 400, the method is not limited thereto, and the length of the second fastening unit 450 may be adjusted in various ways.

In an embodiment, the second connecting member 455 may be provided in plural. The plurality of second connecting members 455 may move to be fixed relative to each other to adjust the length of the second fastening unit 450.

In an embodiment, the plurality of second connecting members 455 may include a third sub-connecting member 455a and a fourth sub-connecting member 455b. One end portion (e.g., the end portion in the +X direction) of the third sub-connecting member 455a may be connected to the third fastening member 451, and one portion of the third sub-connecting member 455a may be connected to the fourth sub-connecting member 455b. One end portion (e.g., the end in the −X direction) of the fourth sub-connecting member 455b may be connected to the fourth fastening member 452, and one portion of the fourth sub-connecting member 455b may be connected to the third sub-connecting member 455a.

In an embodiment, the third sub-connecting member 455a and the fourth sub-connecting member 455b may be connected to each other through the second gear 465. The connection portions of the third sub-connecting member 455a and the fourth sub-connecting member 455b may be changed based on the rotation of the second gear 465.

For example, each of the plurality of second connecting members 455 may include a second rail 456. The second rail 456 may be engaged with the rotation of the second gear 465 and move in a state of being connected to the second gear 465. By the second gear 465 and the second rail 456, the connection portions of the plurality of second connecting members 455 may be changed, and the overall length of the second connecting member 455 may be adjusted.

In an embodiment, the plurality of second connecting members 455 may move to be fixed relative to each other to adjust the length of the second fastening unit 450. As the connection portions of the third sub-connecting member 455a and the fourth sub-connecting member 455b change, the overlapping length of the third sub-connecting member 455a and the fourth sub-connecting member 455b may change, and as a result, the length of the second connecting member 455 may change. As the length of the second connecting member 455 changes, the length of the second fastening unit 450 may be adjusted.

In an embodiment, the second connecting member 455 may be provided inside the second support member 435. The third fastening member 451 may be connected to one end portion of the first support member 431 and the third sub-connecting member 455a, and the fourth fastening member 452 may be connected to an opposite end portion of the first support member 431 opposite to the one end portion and the fourth sub-connecting member 455b.

In an embodiment, when the length of the second connecting member 455 is changed, the distance between the third fastening member 451 and the fourth fastening member 452 may be changed, and the lengths of the fourth fastening member 452 and the third fastening member 451 exposed to the outside of the second support member 435 may be adjusted. By rotating the second gear 465, the third fastening member 451 and the fourth fastening member 452 are introduced into the second support member 435 or discharged outside from the second support member 435, so that the distance between the first support member 431 and the second support member 435 may be adjusted.

In an embodiment, the second connecting member 455 may be a part of the length adjustment unit 460 or the second support member 435. As the length of the second connecting member 455 varies, the length of the second fastening unit 450 exposed to the outside of the second support member 435 may vary, and in the entirety of the wearable device 400, the gap between the first support member 431 and the second support member 435 may be adjusted.

In an embodiment, the length adjustment unit 460 may further include a switch 462. The switch 462 may change the position of the handle 461. For example, the switch 462 may be provided in the second housing 420. When the switch 462 is pressed, the handle 461 in the first position may be changed to the second position, or the handle 461 in the second position may be changed to the first position.

In an embodiment, as the position of the handle 461 is changed, the connection structure with the first fastening unit 440 and the second fastening unit 450 may be changed. The user may manipulate the handle 461 and the switch 462 to adjust the length of each of the first fastening unit 440 and the second fastening unit 450.

For example, FIGS. 8C and 8D may be diagrams illustrating the connection structure of the handle 461 in the first position. In the first position, the handle 461 may be interlocked with the first fastening unit 440 and disconnected from the second fastening unit 450. In the first position, the first gear 464 may be connected to the first connecting member 445, and the second gear 465 may be disconnected from the second connecting member 455.

For example, FIGS. 8E and 8F may be diagrams illustrating the connection structure of the handle 461 in the second position. In the second position, the handle 461 may be interlocked with the second fastening unit 450 and disconnected from the first fastening unit 440. In the second position, the first gear 464 may be disconnected from the first connecting member 445, and the second gear 465 may be connected to the second connecting member 455.

In an embodiment, the length adjustment unit 460 may further include the elastic member 467, a pressure member 468, and a support surface 469. The elastic member 467 or the pressure member 468 may change the position of the handle 461 by applying pressure to the handle 461 while one end portion is supported on the support surface 469.

In an embodiment, the pressure member may be moved by the switch 462, and the handle 461 may be in the first position or the second position based on the position of the pressure member 468. The support surface 469 may support the elastic member 467 and/or an externally withdrawn pillar member 463. The support surface 469 may be provided inside the second support member 435.

In an embodiment, the elastic member 467 may be connected to an end portion of the pillar member 463 in a direction opposite to the handle 461 (e.g., +Y direction). The elastic member 467 may support the handle 461 between the handle 461 and the support surface 469 when the pressure member 468 is disposed inside the pillar member 463 (e.g., the state of the first position).

In an embodiment, the pressure member 468 may support the handle 461 between the handle 461 and the support surface 469 in a state where at least a partial area is withdrawn to the outside of the pillar member 463 (e.g., the state of the second position). The pressure member 468 may be disposed inside the pillar member 463, and at least a partial area may be withdrawn to the outside of the pillar member 463.

For example, the pressure member 468 may pressurize the support surface 469 and push the pillar member 463 while at least a partial area is withdrawn to the outside of the pillar member 463, thereby changing the position of the handle 461 from the first position to the second position. In an alternative embodiment, when the pressure member 468 is inserted into the pillar member 463, the force of the pressure member 468 pressing the pillar member 463 may be reduced or removed, and the position of the handle 461 may be changed from the second position to the first position.

However, the length adjustment unit 460 is merely one of embodiments, and in actual implementation, the length adjustment unit 460 may be implemented in various ways without being limited to the drawings and descriptions of the disclosure, and some components may be omitted, replaced, or added.

For example, the length adjustment unit 460 of an embodiment may omit the first gear 464 and the second gear 465 and include a single length adjustment gear (not shown) that performs both the roles of the first gear 464 and the second gear 465. In an alternative embodiment, the first gear 464 and the second gear 465 may be integrated to form a single length adjustment gear 464, 465.

In an embodiment, the length adjustment gear (not shown) may be interlocked with the first fastening unit 440 and disconnected from the second fastening unit 450 when the handle 461 is in the first position. Also, the length adjustment gear (not shown) may be disconnected from the first fastening unit 440 and connected to the second fastening unit 450 when the handle 461 is in the second position. The length adjustment gear (not shown) may change the connection relationship depending on the position of the handle 461, thereby adjusting the length of each of the first fastening unit 440 or the second fastening unit 450.

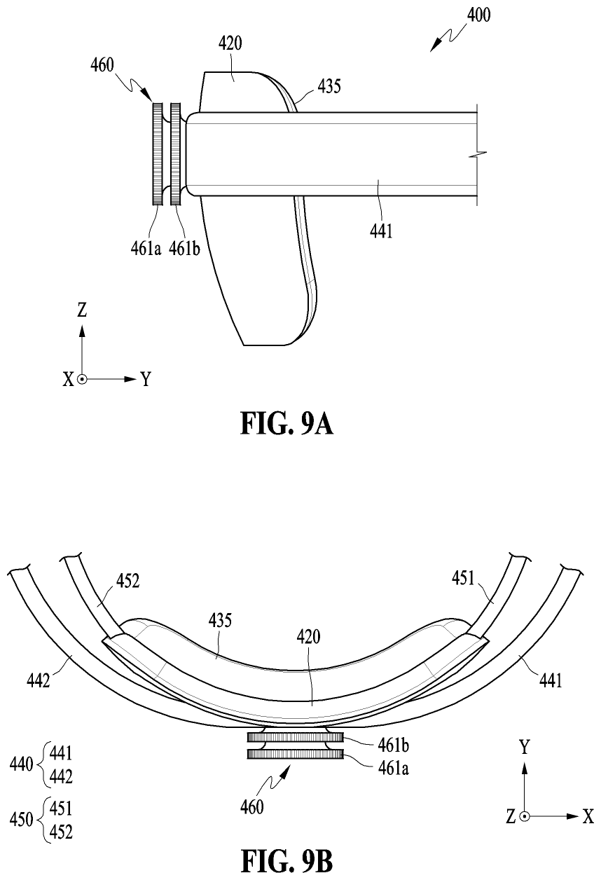

FIG. 9A is a diagram illustrating an embodiment of a partial area of the wearable device 400, and FIG. 9B is a diagram illustrating an embodiment of the length adjustment unit 460.

Referring to FIGS. 9A and 9B, the length adjustment unit 460 in an embodiment may include a first handle 461a and a second handle 461b.

Hereinafter, any repeated description related to the above description is omitted, and it is obvious that a portion of the configuration and structure of the wearable device 400 may be replaced, added, or omitted within a scope easily understandable by one of ordinary skill in the art with reference to the following drawings and descriptions. In addition, at least one component or feature of the embodiments described above may be coupled to the wearable device 400 unless this is technically and clearly infeasible.

In an embodiment, FIGS. 9A and 9B are provided to illustrate an embodiment of the length adjustment unit 460 applicable to the wearable device 400 described above, and some components not shown in the drawings (e.g., the first housing 410 and the first support member 431) may be understood with reference to the above description.

In an embodiment, the second housing 420 and the second support member 435 may be connected to each other to form a single body. For example, the second support member 435 may be a partial area of the second housing 420 provided on the inside of the wearable device 400. Without being limited thereto, the second housing 420 and the second support member 435 may be formed as separate components as in an embodiment of FIGS. 4A and 4B.

In an embodiment, the first handle 461a may be connected to the first fastening unit 440. The first handle 461a may rotate about a rotation axis to adjust the length of the first fastening unit 440.

In an embodiment, the second handle 461b may be connected to the second fastening unit 450. Although not shown in the drawings, the second handle 461b may pass through the first fastening unit 440 or may be non-interlocked with the first fastening unit 440 and connected to the second fastening unit 450. The second handle 461b may rotate about the rotation axis independently of the first handle 461a to adjust the length of the fastening unit.

For example, the length adjustment unit 460 may further include a first gear (e.g., the first gear 464 of FIGS. 8C to 8F) and a first pillar member (not shown) extending along the rotation axis Rx from the first handle 461a. The first pillar member (not shown) may extend toward the first fastening unit 440 in a non-interlocked state with the second handle 461b (e.g., state of penetrating the second handle 461b). The first gear 464 may be interlocked with some components (e.g., the first connecting member 445 of FIGS. 8C to 8F) of the first fastening unit 440, and the first gear 464 may be rotated by the first handle 461a to adjust the length of the first fastening unit 440.

Also, e.g., the length adjustment unit 460 may further include a second gear (e.g., the second gear 465 of FIGS. 8C to 8F) and a second pillar member (not shown) extending along the rotation axis Rx from the second handle 461b. The second pillar member (not shown) may extend toward the second fastening unit 450 in a non-interlocked state with the first handle 461a. The second gear 465 may be interlocked with some components (e.g., the second connecting member 455 of FIGS. 8C to 8F) of the second fastening unit 450, and the second gear 465 may be rotated by the second handle 461b to adjust the length of the second fastening unit 450.

In an embodiment, the wearable device 400 may adjust the lengths of the first fastening unit 440 and the second fastening unit 450 by the first handle 461a and the second handle 461b, respectively, and may provide intuitiveness and convenience to the user.

In an embodiment, the first handle 461a and the second handle 461b may be arranged coaxially. As shown in the drawings, the first handle 461a and the second handle 461b are arranged on one axis so that the user may easily and conveniently adjust the lengths of the first fastening unit 440 and the second fastening unit 450. However, the disclosure is not limited thereto, and the first handle 461a and the second handle 461b may be separated from each other and disposed independently.

In an embodiment, the user may independently adjust each of the first handle 461a and the second handle 461b to adjust the lengths of the first fastening unit 440 and the second fastening unit 450. The user may intuitively wear the wearable device 400 by adjusting two handles 461a and 461b on the same axis without manipulating a separate switch (e.g., the switch 462 of FIGS. 8A to 8F).

In an embodiment, the user may simultaneously manipulate the first handle 461a and the second handle 461b with one hand to remove the wearable device 400, and easily and conveniently take off the wearable device 400.

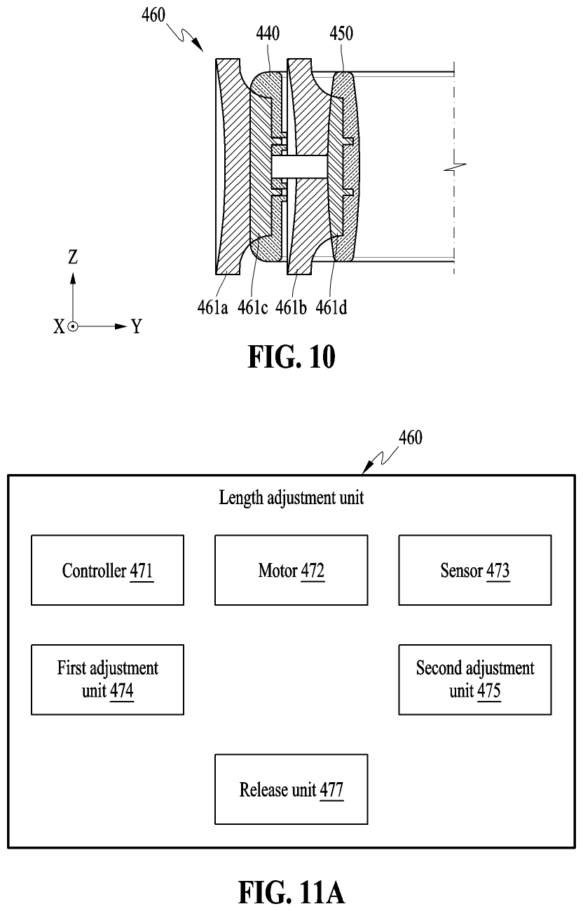

FIG. 10 is a cross-sectional view illustrating an embodiment of the length adjustment unit 460.

Referring to FIG. 10, the length adjustment unit 460 in an embodiment may further include the first handle 461a, the second handle 461b, a first fastener 461c, and a second fastener 461d.

Hereinafter, any repeated description related to the above description is omitted, and it is obvious that a portion of the configuration and structure of the wearable device 400 may be replaced, added, or omitted within a scope easily understandable by one of ordinary skill in the art with reference to the following drawings and descriptions. In addition, at least one component or feature of the embodiments described above may be coupled to the wearable device 400 unless this is technically and clearly infeasible.

In an embodiment, FIG. 10 is provided to illustrate an embodiment of the length adjustment unit 460 applicable to the wearable device 400 described above, and some components not shown in the drawings (e.g., the first housing 410, the second housing 420, the first support member 431, and the second support member 435) may be understood with reference to the above description.

In an embodiment, the first handle 461a and the first fastener 461c may be connected to the first fastening unit 440, and the second handle 461b and the second fastener 461d may be connected to the second fastening unit 450. The first handle 461a and the second handle 461b may be manipulated independently of each other. The wearable device 400 may adjust the lengths of the first fastening unit 440 and the second fastening unit 450 by the first handle 461a and the second handle 461b, respectively.

In an embodiment, the first fastener 461c may be connected to the first fastening unit 440. The first fastener 461c may be rotated by the first handle 461a. For example, the first fastener 461c may include a rack or gear structure that engages with a groove or protrusion of the first fastening unit 440. The first fastener 461c may rotate so that the position where it is engaged with the first fastening unit 440 may be changed, and the first fastener 461c may adjust the length of the first fastening unit 440.

Without being limited thereto, the first fastener 461c may adjust the length of the first fastening unit 440 in various ways. For example, the first fastener 461c may include or consist of a fixing member. The first fastener 461c may be temporarily pulled outward (e.g., the −Y direction) by the first handle 461a.

For example, the wearable device 400 may move the first fastening unit 440 in a state where the first fastener 461c is pulled, and then remove the force that pushes the first fastener 461c again or pulls the first fastener 461c. As the position at which the first fastener 461c is fixed in the first fastening unit 440 is changed, the length of the first fastening unit 440 may be adjusted.

In an embodiment, the second fastener 461d may be connected to the second fastening unit 450. The second fastener 461d may be rotated by the second handle 461b. The second fastener 461d may adjust the length of the second fastening unit 450 in the same or similar manner as the first fastener 461c.

In an embodiment, the second handle 461b and the second fastener 461d may be disposed on a back side (e.g., +Y side) of the first fastening unit 440 as illustrated in the drawings. Without being limited thereto, the second handle 461b and the second fastener 461d may be disposed independently of the first handle 461a and the first fastener 461c.

In an embodiment, when the first handle 461a and the second handle 461b are separated and disposed independently, the user may intuitively adjust the length of each of the first fastening unit 440 and the second fastening unit 450, and the wearable device 400 may provide convenience of use.

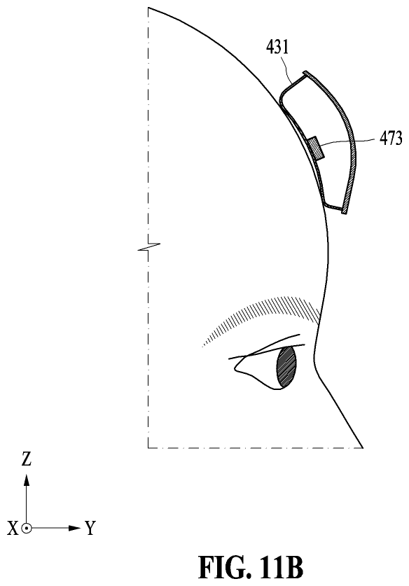

FIG. 11A is a block diagram of an embodiment of the length adjustment unit 460, and FIG. 11B is a diagram illustrating an embodiment of an operation of a sensor 473.

Referring to FIGS. 11A and 11B, the length adjustment unit 460 in an embodiment may include at least some of a controller 471, a motor 472, the sensor 473, a first adjustment unit 474, a second adjustment unit 475, and a release unit 477.

Hereinafter, any repeated description related to the above description is omitted, and it is obvious that a portion of the configuration and structure of the wearable device 400 may be replaced, added, or omitted within a scope easily understandable by one of ordinary skill in the art with reference to the following drawings and descriptions. In addition, at least one component or feature of the embodiments described above may be coupled to the wearable device 400 unless this is technically and clearly infeasible.

In an embodiment, the controller 471 may adjust the lengths of the first fastening unit 440 and the second fastening unit 450. The controller 471 may be connected to the motor 472, which is a power device, and may control the driving of the motor 472. The motor 472 may supply power to the first adjustment unit 474 and the second adjustment unit 475.

In an embodiment, the first adjustment unit 474 may adjust the length of the first fastening unit 440, and the second adjustment unit 475 may adjust the length of the second fastening unit 450. For example, the first adjustment unit 474 may include at least some of the components for controlling the length of the first fastening unit 440, such as a handle (e.g., the handle 461 in the first position of FIGS. 8C and 8D), the first handle 461a, the first fastener 461c, and the first connecting member 445. Similarly, the second adjustment unit 475 may include at least some of the components for controlling the length of the second fastening unit 450, such as the handle (e.g., the handle 461 in the second position of FIGS. 8E and 8F), the second handle 461b, the second fastener 461d, and the second connecting member 455, for example.

In an embodiment, the length adjustment unit 460 may include the controller 471 to electrically adjust the lengths of the first fastening unit 440 and the second fastening unit 450. The controller 471 may be a partial component of a processor (e.g., the processor 120 of FIG. 1) or a memory (e.g., the memory 130 of FIG. 1), or may be a control unit separate from other components of the wearable device 400.

In an embodiment, the sensor 473 may detect a wearing state (e.g., a wearing pressure, a distance, a temperature, or shaking) of the wearable device 400 on the user. The sensor 473 may be provided on one of the first support member 431 or the second support member 435.

In an embodiment, the sensor 473 may be a pressure sensor and may measure the pressure acting on the first support member 431. In an alternative embodiment, the sensor 473 may be a distance sensor and may measure a distance from the first support member 431 to the user.

For example, as illustrated in FIG. 11B, the sensor 473 may be provided on the first support member 431. The sensor 473 may be implemented as a pressure sensor, and may measure the pressure received by the sensor 473 from the forehead of the user in a state where the wearable device 400 is being worn or is worn.

In an embodiment, the sensor 473 may provide a detection result to the controller 471. The controller 471 may control the driving of the motor 472 based on the detection result of the sensor 473.

For example, the controller 471 may control the driving of the motor 472 to reduce the length of the second fastening unit 450 until the pressure acting on the first support member 431 reaches a preset pressure value, or until the distance between the first support member 431 and the user reaches a preset distance value.

For example, the controller 471 may control the driving of the motor 472 to control the tension acting on the second fastening unit 450. The controller 471 may control the tension of the second fastening unit 450 by driving the motor 472 so that the detection result of the sensor 473 reaches a preset appropriate pressure range.

In an embodiment, the release unit 477 may release the fixed state of at least one of the first fastening unit 440 and the second fastening unit 450. In an alternative embodiment, the release unit 477 may remove or reduce the tension of at least one of the first fastening unit 440 and the second fastening unit 450. In an alternative embodiment, the release unit 477 may increase the length of at least one of the first fastening unit 440 and the second fastening unit 450.

For example, when the release unit 477 is driven, the fixed state of the first fastening unit 440 and/or the second fastening unit 450 may be released, and the first fastening unit 440 and/or the second fastening unit 450 may be tensioned.

In an embodiment, the release unit 477 may be a release button provided in the first housing 410 or the second housing 420, or may be a device driven by the control of the controller 471. The user may easily and conveniently take the wearable device 400 off using the release unit 477.

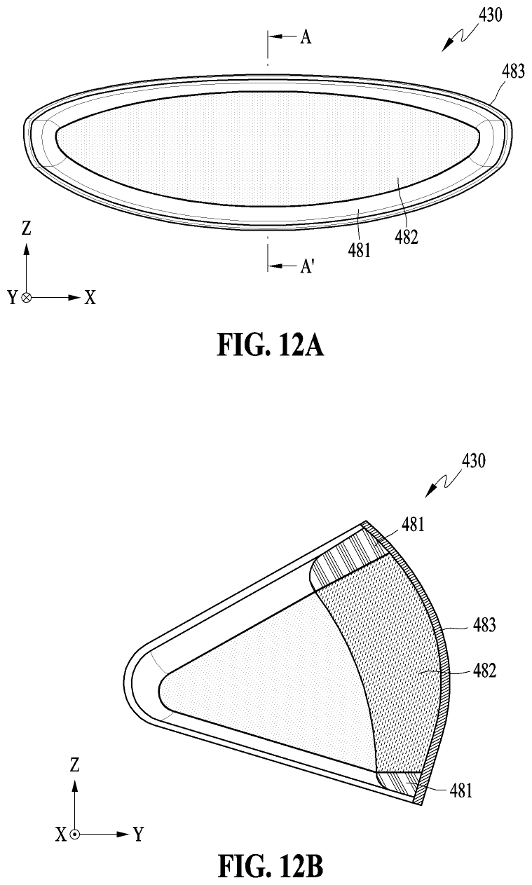

FIG. 12A is a perspective view of an embodiment of the support member 430, and FIG. 12B is a cross-sectional view of an embodiment of the support member 430. Specifically, FIG. 12B is a cross-sectional view of inside of the support member 430 viewed along line A-A′ of FIG. 12A. The support member 430 in an embodiment to be described below may be applied to any one of the first support member 431 or the second support member 435 of the wearable device 400 described above.

Referring to FIGS. 12A and 12B, the support member 430 in an embodiment may include at least some of a first cushion 481, a second cushion 482, and a plate 483.

Hereinafter, any repeated description related to the above description is omitted, and it is obvious that a portion of the configuration and structure of the support member 430 of the wearable device 400 may be replaced, added, or omitted within a scope easily understandable by one of ordinary skill in the art with reference to the following drawings and descriptions. In addition, at least one component or feature of the embodiments described above may be coupled to the support member 430 of the wearable device 400 unless this is technically and clearly infeasible.

In an embodiment, the first cushion 481 and the second cushion 482 may be disposed on the wearable device 400 on the inner side with respect to the user or in a direction (e.g., −Y direction) in which the support member 430 faces the user. The first cushion 481 and the second cushion 482 may relieve pressure between the user and the support member 430 and absorb shock.

In an embodiment, the first cushion 481 and the second cushion 482 may include or consist of a material that is relatively more flexible than the plate 483. For example, the plate 483 may include or consist of a rubber, silicone, or fabric fibers.

In an embodiment, the first cushion 481 and the second cushion 482 may be separated from the plate 483. The user may separate the first cushion 481 and the second cushion 482 to wash or maintain them, and replace at least one of the first cushion 481 and the second cushion 482.

In an embodiment, the first cushion 481 may be disposed on the outside with respect to the center of the support member 430, and the second cushion 482 may be disposed on the inside with respect to the center of the support member 430. The first cushion 481 and the second cushion 482 may include or consist of different materials from each other. The first cushion 481 may be extended relatively further than the second cushion 482 based on the plate 483 and may be in close contact with the forehead or back of the head of the user.

In an embodiment, the plate 483 may be disposed on the wearable device 400 on the opposite side with respect to the user or in a direction (e.g., +Y direction) opposite to the direction in which the support member 430 faces the user. The plate 483 may support the support member 430 and maintain the shape of the support member 430.

In an embodiment, the plate 483 may include or consist of a material that is relatively more rigid than the first cushion 481 and the second cushion 482. For example, the plate 483 may include or consist of a metal alloy, plastic, carbon fiber, or synthetic fiber.

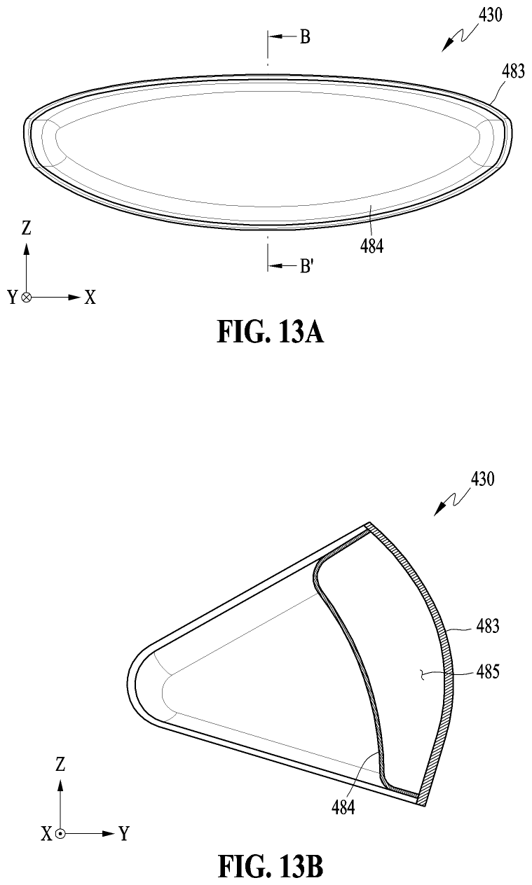

FIG. 13A is a perspective view of an embodiment of the support member 430, and FIG. 13B is a cross-sectional view of the support member 430. Specifically, FIG. 13B is a cross-sectional view of inside of the support member 430 viewed along line B-B′ of FIG. 13A. The support member 430 to be described below may be applied to any one of the first support member 431 or the second support member 435 of the wearable device 400 described above.

Referring to FIGS. 13A and 13B, the support member 430 in an embodiment may include the plate 483 and a support structure 484.

Hereinafter, any repeated description related to the above description is omitted, and it is obvious that a portion of the configuration and structure of the support member 430 of the wearable device 400 may be replaced, added, or omitted within a scope easily understandable by one of ordinary skill in the art with reference to the following drawings and descriptions. In addition, at least one component or feature of the embodiments described above may be coupled to the support member 430 of the wearable device 400 unless this is technically and clearly infeasible.

In an embodiment, the support structure 484 may be disposed on the wearable device 400 on the inside with respect to the user or in a direction (e.g., −Y direction) in which the support member 430 faces the user. The support structure 484 may be open so that an air cushion 485 may be formed between the support structure 484 and the plate 483. The support structure 484 may relieve pressure between the user and the support member 430 and absorb shock.

In an embodiment, the plate 483 may be disposed on the wearable device 400 on the opposite side with respect to the user or in a direction (e.g., +Y direction) opposite to the direction in which the support member 430 faces the user. The plate 483 may support the support member 430 and maintain the shape of the support member 430.

In an embodiment, the support structure 484 may have a shape in which a central portion is inserted toward the plate 483. An outer side of the support structure 484 may be relatively extended further to come into close contact with the forehead or back of the head of the user.

In an embodiment, the air cushion 485 may be formed between the support structure 484 and the plate 483. Through the air cushion 485, the shape of the support structure 484 may be changed and temporarily changed by shock or pressure. As the shape of the support structure 484 is changed, the shock or pressure received by the user may be alleviated.

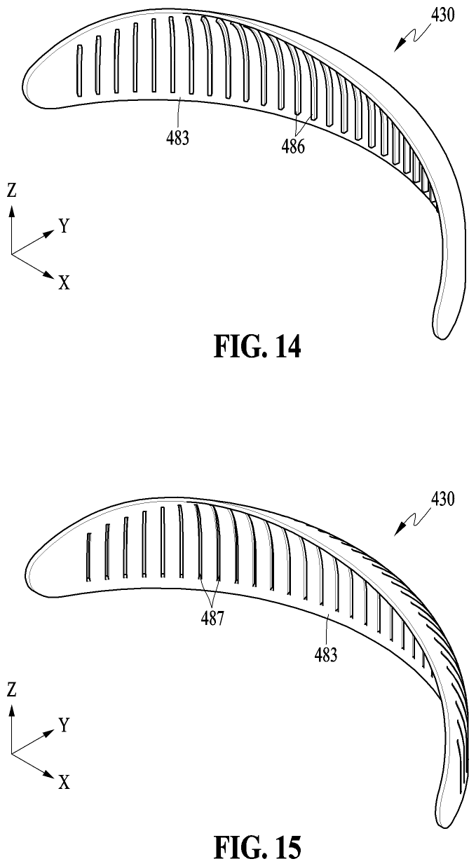

FIG. 14 is a perspective view of an embodiment of the support member 430, and FIG. 15 is a perspective view of the support member 430.

Referring to FIG. 14 or 15, the support member 430 in an embodiment may include at least one of a plurality of ribs 486, or a plurality of openings 487 may be defined in support member 430. The support member 430 in an embodiment to be described below may be applied to any one of the first support member 431 or the second support member 435 of the wearable device 400 described above.

Hereinafter, any repeated description related to the above description is omitted, and it is obvious that a portion of the configuration and structure of the support member 430 of the wearable device 400 may be replaced, added, or omitted within a scope easily understandable by one of ordinary skill in the art with reference to the following drawings and descriptions. In addition, at least one component or feature of the embodiments described above may be coupled to the support member 430 of the wearable device 400 unless this is technically and clearly infeasible.

In an embodiment, as illustrated in FIG. 14, the plurality of ribs 486 may be provided inwardly from the plate 483. The plurality of ribs 486 may be spaced apart from each other and may extend along one direction (e.g., Z-axis direction) on one surface of the plate 483.

In an embodiment, the plurality of ribs 486 may reinforce the flexibility of the support member 430. The plurality of ribs 486 may include or consist of a material that is relatively more flexible than the plate 483. The plurality of ribs 486 may be connected to other components (e.g., the first cushion 481, the second cushion 482, or the support structure 484) to support them or absorb shock or pressure. The support member 430 may provide wearing convenience of the support member 430 through the plurality of ribs 486.

In an embodiment, as illustrated in FIG. 15, the plurality of openings 487 may be provided in the plate 483. The plurality of openings 487 may be spaced apart from each other and may extend along one direction (e.g., the Z-axis direction) on one surface of the plate 483.

In an embodiment, the plurality of openings 487 may reinforce the flexibility of the support member 430. Through the plurality of openings 487, the plate 483 may be deformed within a predetermined range. The plurality of openings 487 may be inlets through which internal or external air of the support member 430 moves. Through the plurality of openings 487, air or moisture inside the support member 430 may be discharged to the outside of the support member 430. Also, the plurality of openings 487 may reduce a weight of the support member 430 and provide wearing convenience.

The effects to be achieved are not limited to those described above, and other effects not mentioned above will be clearly understood by one of ordinary skill in the art from the following description.

In an embodiment, the wearable device 400 may include the first housing 410, the second housing 420 spaced apart from the first housing 410, the first support member 431 connected to the first housing 410, the second support member 435 connected to the second housing 420, the first fastening unit 440 connecting the first housing 410 and the second housing 420, the second fastening unit 450 connecting the first support member 431 and the second support member 435, and the length adjustment unit 460 adjusting a length of each of the first fastening unit 440 and the second fastening unit 450.

In an embodiment, the length adjustment unit 460 may include the handle 461 that is provided in the second housing 420 and rotates along a rotation axis.

In an embodiment, the handle 461 may selectively change a position between a first position and a second position. In an embodiment, in the first position, the handle 461 may be interlocked with the first fastening unit 440 and disconnected from the second fastening unit 450. In an embodiment, in the second position, the handle 461 may be interlocked with the second fastening unit 450 and disconnected from the first fastening unit 440.

In an embodiment, the length adjustment unit 460 may include the pillar member 463 extending from the handle 461 along the rotation axis, the first gear 464 provided in a partial area of an outer circumferential surface of the pillar member 463 and connectable to the first fastening unit 440, and the second gear 465 provided in another partial area of the outer circumferential surface of the pillar member 463 and connectable to the second fastening unit 450.

In an embodiment, the first fastening unit 440 may include the first connecting member 445 that engages with the first gear 464 and a length of which changes by rotation of the first gear 464, in a state where the first fastening unit 440 is connected to the first gear 464.

In an embodiment, the first connecting member 445 may be provided inside the second housing 420. In an embodiment, the first fastening unit 440 may include the first fastening member 441 connecting one end portion of the first housing 410 and the first connecting member 445, and the second fastening member 442 connecting an opposite end portion of the first housing 410 opposite to the one end portion and the first connecting member 445.

In an embodiment, the second fastening unit 450 may include the second connecting member 455 that engages with the second gear 465 and a length of which changes by rotation of the second gear 465, in a state where the second fastening unit 450 is connected to the second gear 465.

In an embodiment, the second connecting member 455 may be provided inside the second support member 435. In an embodiment, the second fastening unit 450 may include the third fastening member 451 connecting one end portion of the first support member 431 and the second connecting member 455, and the fourth fastening member 452 connecting an opposite end portion of the first support member 431 opposite to the one end portion and the second connecting member 455.

In an embodiment, the length adjustment unit 460 may include the first handle 461a connected to the first fastening unit 440 and adjusting the length of the first fastening unit 440 by rotating about a rotation axis, and the second handle 461b connected to the second fastening unit 450 and adjusting the length of the second fastening unit 450 by rotating about a rotation axis independently of the first handle 461a.

In an embodiment, the second handle 461b may be disposed coaxially with the first handle 461a.

In an embodiment, the length adjustment unit 460 may include the first adjustment unit 474 adjusting the length of the first fastening unit 440, the second adjustment unit 475 adjusting the length of the second fastening unit 450, the motor 472 supplying power to the first adjustment unit 474 and the second adjustment unit 475, and the controller 471 controlling driving of the motor 472.

In an embodiment, the length adjustment unit 460 may further include the sensor 473 that is provided on one of the first support member 431 and the second support member 435 and detects a wearing state of a user. In an embodiment, the controller 471 may receive a detection result from the sensor 473 and control driving of the motor 472.

In an embodiment, the second fastening unit 450 may be disposed closer to an inner center of the wearable device 400 than the first fastening unit 440 is to the inner center of the wearable device 400.

In an embodiment, the second fastening unit 450 may include or consist of a material that is relatively more flexible than the first fastening unit 440.

In an embodiment, the first fastening unit 440 may include a connecting unit (not shown) for electrically connecting the first housing 410 and the second housing 420.

In addition, the wearable device 400 may include the first housing 410 accommodating a first electronic component (not shown), the second housing 420 accommodating a second electronic component (not shown) and spaced apart from the first housing 410, the first support member 431 connected to the first housing 410, the second support member 435 connected to the second housing 420, the first fastening unit 440 that includes a connecting unit (not shown) electrically connecting the first electronic component (not shown) and the second electronic component (not shown), and connects the first housing 410 and the second housing 420, the second fastening unit 450 that is disposed closer to an inner center of the wearable device 400 than the first fastening unit 440 is to the inner center of the wearable device 400, and connects the first support member 431 and the second support member 435, and the length adjustment unit 460 adjusting a length of each of the first fastening unit 440 and the second fastening unit 450.

In an embodiment, the length adjustment unit 460 may include the handle 461 that is provided in the second housing 420, rotates along a rotation axis, and selectively changes a position between a first position and a second position. In an embodiment, in the first position, the handle 461 may be interlocked with the first fastening unit 440 and disconnected from the second fastening unit 450. In an embodiment, in the second position, the handle 461 may be interlocked with the second fastening unit 450 and disconnected from the first fastening unit 440.

In an embodiment, the handle 461 may include the pillar member 463 extending from the second housing 420 to the second support member 435 along the rotation axis, the first gear 464 provided in a partial area of an outer circumferential surface of the pillar member 463 and connectable to the first fastening unit 440, and the second gear 465 provided in another partial area of the outer circumferential surface of the pillar member 463 and connectable to the second fastening unit 450.

In an embodiment, the first fastening unit 440 may include the first connecting member 445 that is provided inside the second housing 420 and engages with the first gear 464 and a length of which changes by rotation of the first gear 464, in a state where the first fastening unit 440 is connected to the first gear 464, the first fastening member 441 connecting one end portion of the first housing 410 and the first connecting member 445, and the second fastening member 442 connecting an opposite end portion of the first housing 410 opposite to the one end portion and the first connecting member 445.

In an embodiment, the second fastening unit 450 may include the second connecting member 455 that is provided inside the second support member 435 and moves while engaging with the second gear 465 when connected to the second gear 465, and a length of which changes based on a rotation direction of the second gear 465, in a state where the second fastening unit 450 is connected to the second gear 465, the third fastening member 451 connecting one end portion of the first support member 431 and the second connecting member 455, and the fourth fastening member 452 connecting an opposite end portion of the first support member 431 opposite to the one end portion and the second connecting member 455.

While embodiments have been illustrated and described above, the disclosure is not limited to the aforementioned illustrative embodiments. Those skilled in the art should appreciate that various modifications may be made to the embodiments without departing from the subject matter of the disclosure as defined by the appended claims, and also that such modifications are not to be understood individually from the technical spirit or prospect of the disclosure.

What is claimed is:

1. A wearable device comprising:
a first housing;
a second housing spaced apart from the first housing;
a first support member connected to the first housing;
a second support member connected to the second housing;
a first fastening unit which connects the first housing and the second housing;
a second fastening unit which connects the first support member and the second support member; and
a length adjustment unit which adjusts a length of each of the first fastening unit and the second fastening unit.

2. The wearable device of claim 1, wherein the length adjustment unit comprises a handle which is provided in the second housing and rotates along a rotation axis.

3. The wearable device of claim 2, wherein
the handle selectively changes a position between a first position and a second position,
in the first position, the handle is interlocked with the first fastening unit and disconnected from the second fastening unit, and
in the second position, the handle is interlocked with the second fastening unit and disconnected from the first fastening unit.

4. The wearable device of claim 1, wherein the length adjustment unit comprises:
a pillar member extending from the handle along the rotation axis;
a first gear provided in a partial area of an outer circumferential surface of the pillar member and connectable to the first fastening unit; and
a second gear provided in another partial area of the outer circumferential surface of the pillar member and connectable to the second fastening unit.

5. The wearable device of claim 4, wherein the first fastening unit comprises a first connecting member which engages with the first gear and a length of which changes by rotation of the first gear, in a state where the first fastening unit is connected to the first gear.

6. The wearable device of claim 5, wherein
the first connecting member is provided inside the second housing, and
the first fastening unit comprises:
a first fastening member connecting one end portion of the first housing and the first connecting member; and
a second fastening member connecting an opposite end portion of the first housing opposite to the one end portion and the first connecting member.

7. The wearable device of claim 6, wherein the second fastening unit comprises a second connecting member which engages with the second gear and a length of which changes by rotation of the second gear, in a state where the second fastening unit is connected to the second gear.

8. The wearable device of claim 7, wherein
the second connecting member is provided inside the second support member, and
the second fastening unit comprises:
a third fastening member connecting one end portion of the first support member and the second connecting member; and
a fourth fastening member connecting an opposite end portion of the first support member opposite to the one end portion and the second connecting member.

9. The wearable device of claim 1, wherein the length adjustment unit comprises:
a first handle connected to the first fastening unit and adjusting the length of the first fastening unit by rotating about a rotation axis; and
a second handle connected to the second fastening unit and adjusting the length of the second fastening unit by rotating about a rotation axis independently of the first handle.

10. The wearable device of claim 9, wherein the second handle is disposed coaxially with the first handle.

11. The wearable device of claim 1, wherein the length adjustment unit comprises:
a first adjustment unit which adjusts the length of the first fastening unit;
a second adjustment unit which adjusts the length of the second fastening unit;
a motor which supplies power to the first adjustment unit and the second adjustment unit; and
a controller which controls driving of the motor.

12. The wearable device of claim 11, wherein
the length adjustment unit further comprises a sensor which is provided on one of the first support member and the second support member and detects a wearing state of a user, and
the controller receives a detection result from the sensor and controls driving of the motor.

13. The wearable device of claim 1, wherein the second fastening unit is disposed closer to an inner center of the wearable device than the first fastening unit is to the inner center of the wearable device.

14. The wearable device of claim 13, wherein the second fastening unit includes a material which is relatively more flexible than the first fastening unit.

15. The wearable device of claim 1, wherein the first fastening unit comprises a connecting unit for electrically connecting the first housing and the second housing.

16. A wearable device, comprising:
a first housing which accommodates a first electronic component;
a second housing which accommodates a second electronic component and spaced apart from the first housing;
a first support member connected to the first housing;
a second support member connected to the second housing;
a first fastening unit which comprises:
a connecting unit electrically which connects the first electronic component and the second electronic component, and connects the first housing and the second housing;
a second fastening unit which is disposed closer to an inner center of the wearable device than the first fastening unit is to the inner center of the wearable device, and connects the first support member and the second support member; and
a length adjustment unit which adjusts a length of each of the first fastening unit and the second fastening unit.

17. The wearable device of claim 16, wherein
the length adjustment unit comprises a handle which is provided in the second housing, rotates along a rotation axis and selectively changes a position between a first position and a second position,
in the first position, the handle is interlocked with the first fastening unit and disconnected from the second fastening unit, and
in the second position, the handle is interlocked with the second fastening unit and disconnected from the first fastening unit.

18. The wearable device of claim 17, wherein the handle comprises:
a pillar member extending from the second housing to the second support member along the rotation axis;
a first gear provided in a partial area of an outer circumferential surface of the pillar member and connectable to the first fastening unit; and
a second gear provided in another partial area of the outer circumferential surface of the pillar member and connectable to the second fastening unit.

19. The wearable device of claim 18, wherein the first fastening unit comprises:
a first connecting member which is provided inside the second housing and engages with the first gear and a length of which changes by rotation of the first gear, in a state where the first fastening unit is connected to the first gear;
a first fastening member connecting one end portion of the first housing and the first connecting member; and
a second fastening member connecting an opposite end portion of the first housing opposite to the one end portion and the first connecting member.

20. The wearable device of claim 18, wherein the second fastening unit comprises:
a second connecting member which is provided inside the second support member and moves while engaging with the second gear when connected to the second gear, and a length of which changes based on a rotation direction of the second gear, in a state where the second fastening unit is connected to the second gear;
a third fastening member connecting one end portion of the first support member and the second connecting member; and
a fourth fastening member connecting an opposite end portion of the first support member opposite to the one end portion and the second connecting member.
